(19) United States
(12) Patent Application Publication
(10) Pub. No.: US 2026/0146055 A1
(43) Pub. Date: May 28, 2026

(54) Ligand Compound, Transition Metal Compound, and Catalyst Composition Including the Same

(71) Applicant: LG Chem, Ltd., Seoul (KR)

(72) Inventors: Seok Pil Sa, Daejeon (KR); Eun Ji Shin, Daejeon (KR); Seul Ki Im, Daejeon (KR); Hyun Mo Lee, Daejeon (KR); Ki Soo Lee, Daejeon (KR); Bun Yeoul Lee, Gyeonggi-do (KR); Kyung Lee Park, Seoul (KR)

(73) Assignee: LG Chem, Ltd., Seoul (KR)

(21) Appl. No.: 19/453,774

(22) Filed: Jan. 20, 2026

Related U.S. Application Data
(63) Continuation of application No. 17/780,300, now Pat. No. 12,570,678.

(30) Foreign Application Priority Data
Apr. 16, 2020 (KR) 10-2020-0046030

(51) Int. Cl. C07F 7/28; B01J 31/18; C08F 4/64; C08F 4/659

(52) U.S. Cl. CPC C07F 7/28; B01J 31/1825; C08F 4/64; C08F 4/65912

(57) ABSTRACT

The present invention relates to a ligand compound having a novel structure of the following:

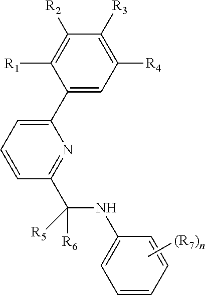

wherein R₁ to R₇, and n are described herein.

### CROSS-REFERENCE TO RELATED APPLICATIONS

The present application is a divisional application of U.S. application Ser. No. 17/780,300 filed on May 26, 2022, a national stage entry under 35 U.S.C. § 371 of International Application No. PCT/KR2021/004813 filed on Apr. 16, 2021, which claims priority from Korean Patent Application No. 10-2020-0046030 filed on Apr. 16, 2020, all the disclosures of which are incorporated herein by reference.

### TECHNICAL FIELD

The present invention relates to a ligand compound having a novel structure, a transition metal compound, and a catalyst composition including the same.

### BACKGROUND ART

Transition metal pincer complexes have been widely applied in the field of organometallic catalysis. Tridentate chelating pincer ligands are combined with a metal to form a planar structure with the metal at the center. Ligand-metal interaction is rigid and inflexible, and thus, high stability is provided.

For homogeneous olefin polymerization, the initial Zr-based metallocene catalyst developed in to Ti-based half-metallocene, and finally to a post-metallocene having a bicyclopentadienyl ligand. Among the post-metallocenes developed, the pincer-type [C^{naphthy}, N^{pyridine}, N^{amido}]HfMe₂ complex is a main catalyst. This complex has been developed in the early 2000s through high-throughput screening and has been extensively researched, and is applied in commercial processes.

Such a complex may introduce a large amount of alpha-olefin in an ethylene/alpha-olefin copolymerization, and may control the tacticity of propylene polymerization for preparing isotactic polypropylene. Another advantage of this complex is the lack of β-elimination process, which is a unique chain transfer reaction inevitable in olefin polymerization using the conventional Zr-based metallocene and Ti-based half-metallocene catalysts. Due to such characteristics, a polyolefin chain may be grown from an Hf-site, and transferred to a chain transfer agent such as diethylzinc (Et2Zn) to grow uniform polyolefin chains. Such a process is referred to as coordinative chain transfer polymerization (CCTP). CCTP technique may be utilized for the commercial production of an olefin block copolymer.

In addition, a polyolefin-polystyrene block copolymer may be synthesized through the anionic polymerization of styrene using a complex in a reaction after CCTP. As described above, a transition metal compound including a hafnium metal may be useful as a catalyst for producing olefin based polymers, and a great deal of research for improving catalyst performance by modifying thereof is being conducted.

### PRIOR ART DOCUMENT

### Patent Document

Korean Laid-open Patent No. 10-2018-0055531

### DISCLOSURE OF THE INVENTION

### Technical Problem

An object of the present invention is to provide a novel transition metal compound, a ligand compound and a catalyst composition including the same.

### Technical Solution

In order to solve the above-described tasks, the present invention provides a transition metal compound represented by the following Formula 1:

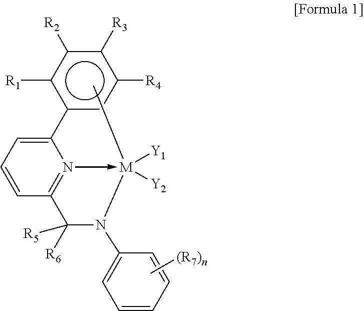

in Formula 1,
M is Ti, Zr or Hf,
R₁ to R₄ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where adjacent two or more among them may be connected from each other to form a ring,
R₅ and R₆ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where the substitution is conducted with an alkyl group of 1 to 12 carbon atoms,
each R₇ is independently a substituted or unsubstituted alkyl group of 4 to 20 carbon atoms; a substituted or unsubstituted cycloalkyl group of 4 to 20 carbon atoms; or a substituted or unsubstituted aryl group of 6 to 20 carbon atoms,
n is 1 to 5, and
Y₁ and Y₂ are each independently a halogen group; a substituted or unsubstituted alkyl group of 1 to 20 carbon atoms; a substituted or unsubstituted alkenyl group of 2 to 20 carbon atoms; a substituted or unsubstituted alkynyl group or 2 to 20 carbon atoms; a substituted or unsubstituted cycloalkyl group of 3 to 20 carbon atoms; a substituted or unsubstituted aryl group of 6 to 20 carbon atoms; a substituted or unsubstituted alkylaryl group of 7 to 20 carbon atoms; a substituted or unsubstituted arylalkyl group of 7 to 20 carbon atoms; a substituted or unsubstituted heteroaryl group of 5 to 20 carbon atoms; a substituted or unsubstituted alkoxy group of 1 to 20 carbon atoms; a substituted or unsubstituted aryloxy group of 6 to 20 carbon atoms; a substituted or unsubstituted alkylamino group of 1 to 20 carbon atoms; a substituted or unsubstituted arylamino group of 5 to 20 carbon atoms; a substituted or unsubstituted alkylthio group of 1 to 20 carbon atoms; a substituted or unsubstituted arylthio group of 5 to 20 carbon atoms; a substituted or unsubstituted alkylsilyl group of 1 to 20 carbon atoms; a substituted or unsubstituted arylsilyl group of 5 to 20 carbon atoms; a hydroxyl group; an amino group; a thio group; a silyl group; a cyano group; or a nitro group.

In addition, an embodiment of the present invention provides a catalyst composition including the transition metal compound represented by Formula 1 and a cocatalyst.

In addition, an embodiment of the present invention provides a method for preparing on olefin polymer, including polymerizing an olefin monomer in the presence of the catalyst composition.

### Advantageous Effects

The novel transition metal compound of the present invention may be useful as a catalyst of polymerization reaction for preparing an olefin polymer having a high molecular weight.

### BRIEF DESCRIPTION OF DRAWINGS

FIG. 1 shows a ¹H NMR spectrum and a ¹³C NMR spectrum of Example 1.

FIG. 2 shows a ¹H NMR spectrum and a ¹³C NMR spectrum of Example 2.

FIG. 3 shows a ¹H NMR spectrum and a ¹³C NMR spectrum of Example 3.

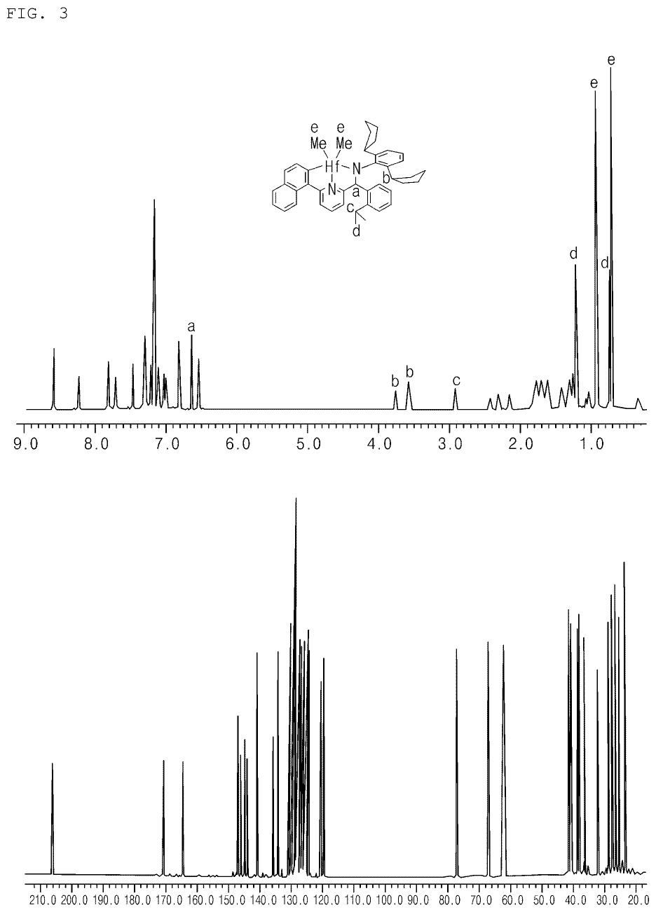

FIG. 4 shows a ¹H NMR spectrum and a ¹³C NMR spectrum of Example 4.

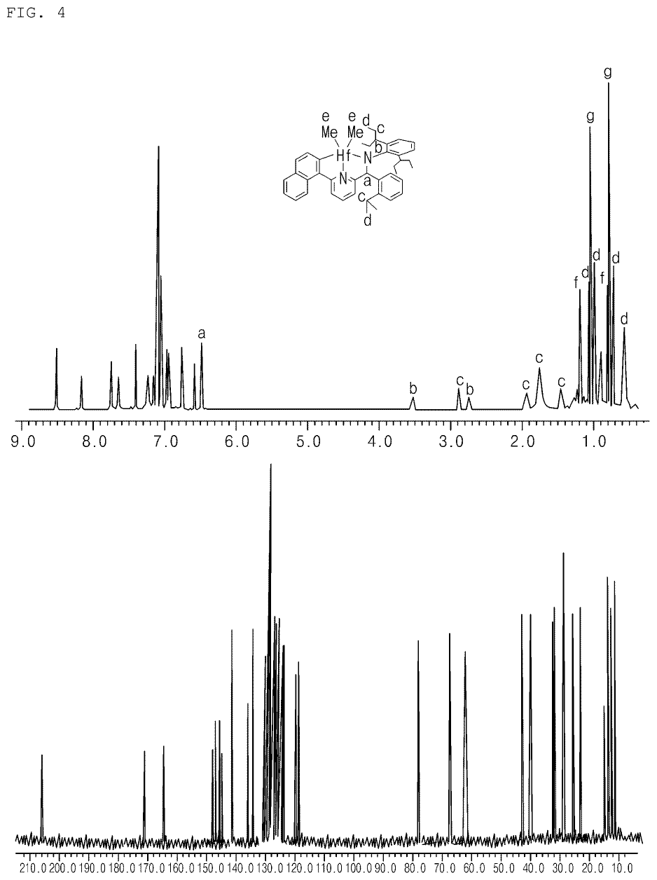

FIG. 5 shows a ¹H NMR spectrum and a ¹³C NMR spectrum of Example 5.

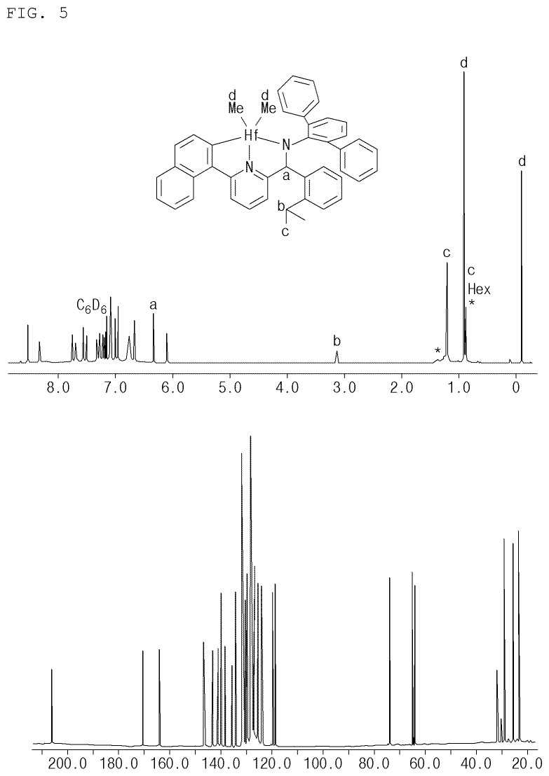

FIG. 6 shows a ¹H NMR spectrum and a ¹³C NMR spectrum of Example 6.

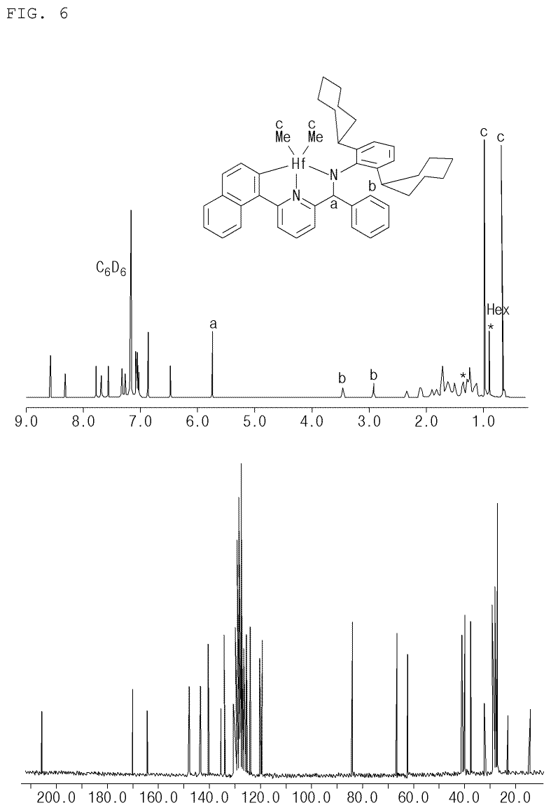

FIG. 7 shows a ¹H NMR spectrum and a ¹³C NMR spectrum of Example 7.

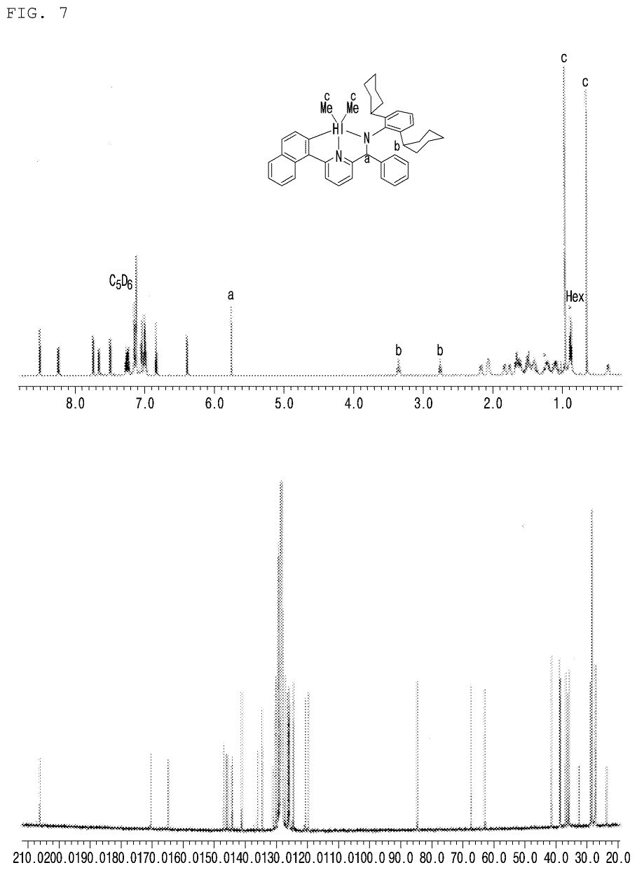

FIG. 8 shows a ¹H NMR spectrum and a ¹³C NMR spectrum of Example 8.

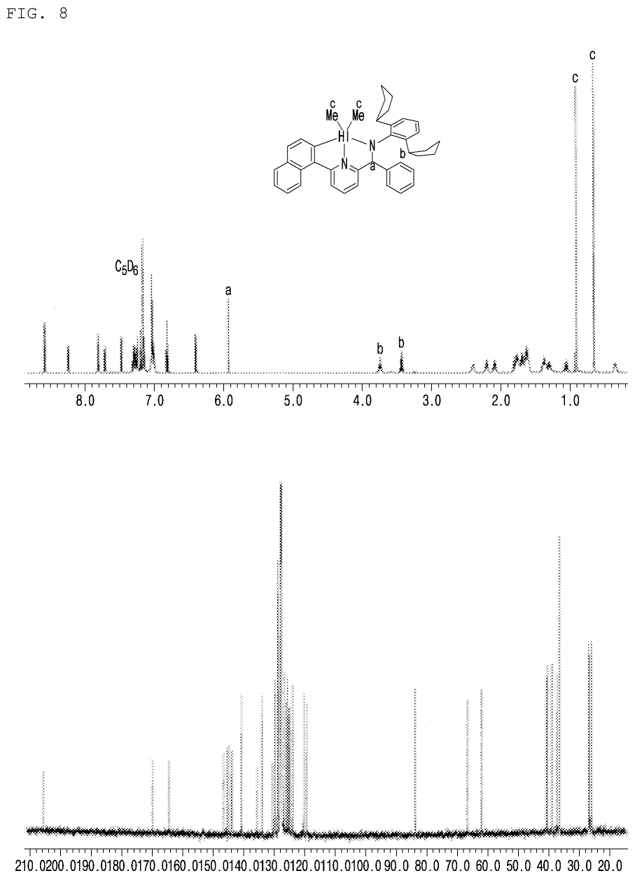

FIG. 9 shows a graph on ethylene consumed amount in accordance with time for Example 2 and Comparative Example 1 using a mass flow controller (MFC).

### BEST MODE FOR CARRYING OUT THE INVENTION

Hereinafter, the present invention will be explained in more detail to assist the understanding of the present invention.

It will be understood that words or terms used in the description and claims of the present invention shall not be interpreted as the meaning defined in commonly used dictionaries. It will be further understood that the words or terms should be interpreted as having a meaning that is consistent with their meaning of the technical idea of the invention, based on the principle that an inventor may properly define the meaning of the words or terms to best explain the invention.

In the present invention, “alkyl” means a hydrocarbon residue of a linear chain or a branched chain.

In the present invention, “alkenyl” means an alkenyl group of a linear chain or a branched chain.

In the present invention, “aryl” preferably has 6 to 20 carbon atoms, and particularly includes phenyl, naphthyl, anthracenyl, dimethylanilinyl, anisolyl, etc., without limitation.

In the present invention, “alkylaryl” means an aryl group substituted with the alkyl group.

In the present invention, “arylalkyl” means an alkyl group substituted with the aryl group.

In the present invention, “alkylsilyl” may be silyl substituted with alkyl of 1 to 20 carbon atoms, for example, trimethylsilyl or triethylsilyl.

In the present invention, “alkylamino” means an amino group substituted with the alkyl group and includes a dimethylamino group, a diethylamino group, etc., but is not limited thereto.

In the present invention, “hydrocarbyl” means a monovalent hydrocarbon group of 1 to 20 carbon atoms, composed of only carbon and hydrogen irrespective of its structure, including alkyl, aryl, alkenyl, alkynyl, cycloalkyl, alkylaryl or arylalkyl.

An embodiment of the present invention provides a transition metal compound represented by the following Formula 1:

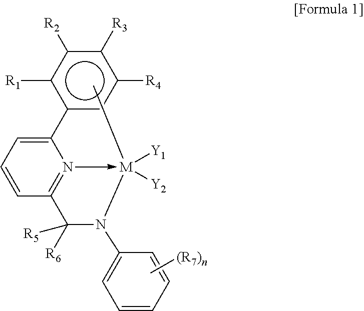

in Formula 1,
M is Ti, Zr or Hf,
R₁ to R₄ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where adjacent two or more among them may be connected from each other to form a ring,
R₅ and R₆ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where the substitution is conducted with an alkyl group of 1 to 12 carbon atoms,
each R₇ is independently a substituted or unsubstituted alkyl group of 4 to 20 carbon atoms; a substituted or unsubstituted cycloalkyl group of 4 to 20 carbon atoms; or a substituted or unsubstituted aryl group of 6 to 20 carbon atoms,
n is 1 to 5, and
Y₁ and Y₂ are each independently a halogen group; a substituted or unsubstituted alkyl group of 1 to 20 carbon atoms; a substituted or unsubstituted alkenyl group of 2 to 20 carbon atoms; a substituted or unsubstituted alkynyl group or 2 to 20 carbon atoms; a substituted or unsubstituted cycloalkyl group of 3 to 20 carbon atoms; a substituted or unsubstituted aryl group of 6 to 20 carbon atoms; a substituted or unsubstituted alkylaryl group of 7 to 20 carbon atoms; a substituted or unsubstituted arylalkyl group of 7 to 20 carbon atoms; a substituted or unsubstituted heteroaryl group of 5 to 20 carbon atoms; a substituted or unsubstituted alkoxy group of 1 to 20 carbon atoms; a substituted or unsubstituted aryloxy group of 6 to 20 carbon atoms; a substituted or unsubstituted alkylamino group of 1 to 20 carbon atoms; a substituted or unsubstituted arylamino group of 5 to 20 carbon atoms; a substituted or unsubstituted alkylthio group of 1 to 20 carbon atoms; a substituted or unsubstituted arylthio group of 5 to 20 carbon atoms; a substituted or unsubstituted alkylsilyl group of 1 to 20 carbon atoms; a substituted or unsubstituted arylsilyl group of 5 to 20 carbon atoms; a hydroxyl group; an amino group; a thio group; a silyl group; a cyano group; or a nitro group.

If polymerization reaction is performed in the presence of an excessive amount of a chain transfer agent (for example, (Et)₂Zn) with respect to a catalyst, an olefin polymer chain may undergo rapid transalkylation between zinc (Zn) and hafnium (Hf) for uniform propagation from dialkylzinc to accomplish living polymerization, and this is referred to as coordinative chain transfer polymerization (CCTP). The conventionally used metallocene catalysts precluded living polymerization due to a β-elimination process, and a small number of catalysts well-known as being applicable to CCTP enabled only homopolymerization of ethylene but made the copolymerization of ethylene and alpha-olefin through CCTP very difficult. Accordingly, the living polymerization through CCTP using a common transition metal compound as a catalyst to prepare a block copolymer was difficult.

The transition metal compound of the present invention is characterized in including a bulky functional group for R₇ in Formula 1, and through this, high catalyst activity was accomplished. In case of positioning a functional group having a small size, for example, an isopropyl group, for R₇, the isopropyl group and a hafnium compound may react, and catalyst deactivation reaction may be carried out, on the contrary, the functional group positioned at R₇ effectively reduces the deactivation reaction of the compound of the present invention and improves stability, as well as reducing the activation energy in polymerization reaction and showing excellent catalyst activity.

As described above, the transition metal compound of the present invention may be usefully used as a catalyst for preparing an olefin polymer, and this is intrinsic characteristic for accomplishing by the novel structure of the compound newly developed in the present invention.

Particularly, in Formula 1, M may be Hf.

Particularly, in Formula 1, R₁ to R₄ are each independently hydrogen; or a substituted or unsubstituted alkyl group of 1 to 20 carbon atoms; where adjacent two or more among them may be connected from each other to form a ring, or R₁ and R₂ are each independently an alkyl group of 1 to 20 carbon atoms and are connected from each other to form an aromatic ring of 5 to 20 carbon atoms, and R₃ and R₄ may be hydrogen.

Particularly, in Formula 1, R₅ and R₆ may be each independently hydrogen; or a substituted or unsubstituted aryl group of 6 to 20 carbon atoms, where the substitution is conducted with an alkyl group of 1 to 6 carbon atoms.

Particularly, in Formula 1, each R₇ may be independently a substituted or unsubstituted alkyl group of 4 to 20 carbon atoms; a substituted or unsubstituted cycloalkyl group of 4 to 20 carbon atoms; or a substituted or unsubstituted aryl group of 6 to 20 carbon atoms.

Particularly, in Formula 1, n may be 1 to 3, preferably, 2.

Particularly, in Formula 1, Y₁ and Y₂ may be each independently an alkyl group of 1 to 20 carbon atoms.

More particularly, the transition metal compound represented by Formula 1 may be a compound represented by the following Formula 1a:

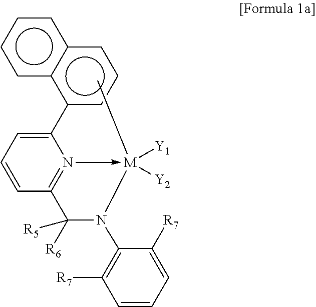

in Formula 1a,
M, R₅ to R₇, Y₁ and Y₂ are the same as defined above.

The transition metal compound represented by Formula 1 may particularly be selected from the compounds below, but all transition metal compounds corresponding to Formula 1 are included in the present invention, without limitation.

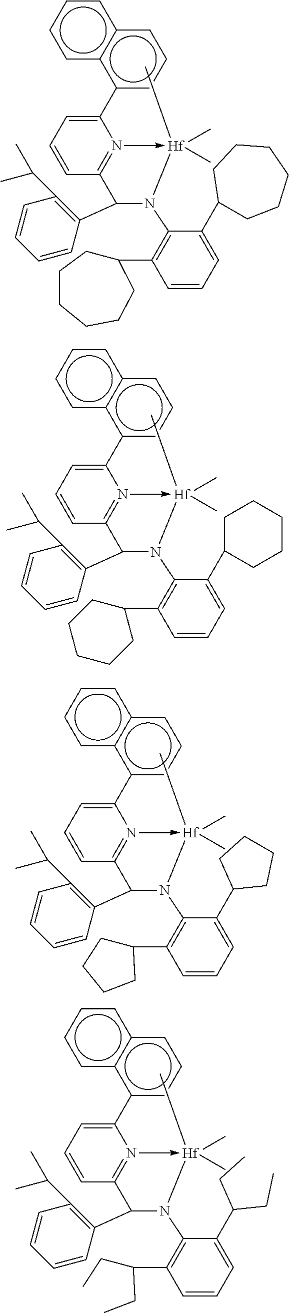

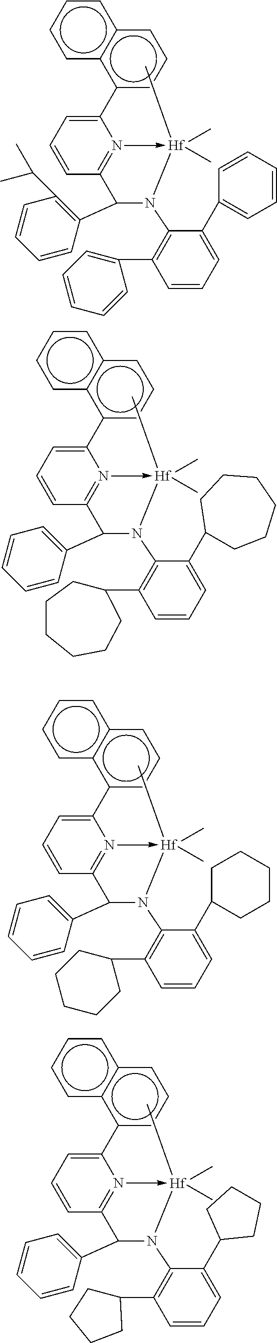

In addition, the present invention provides a ligand compound represented by the following Formula 2:

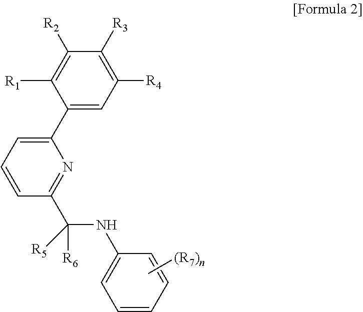

in Formula 2,
R₁ to R₄ are each independently hydrogen, a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where adjacent two or more among them may be connected from each other to for a ring,
R₅ and R₆ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where the substitution is conducted with an alkyl group of 1 to 12 carbon atoms,
each R₇ is independently a substituted or unsubstituted alkyl group of 4 to 20 carbon atoms; a substituted or unsubstituted cycloalkyl group of 4 to 20 carbon atoms; or a substituted or unsubstituted aryl group of 6 to 20 carbon atoms, and
n is 1 to 5.

That is, the transition metal compound of the present invention may be prepared by including: reacting a ligand compound represented by the following Formula 2 and a compound represented by the following Formula 3:

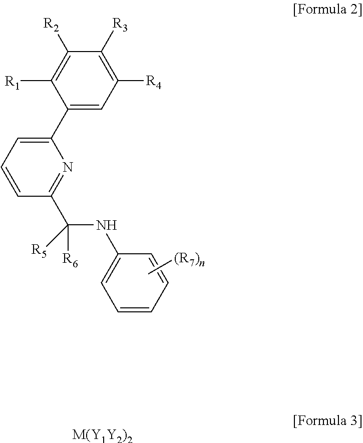

in the above formulae,
R₁ to R₇, M, Y₁ and Y₂ are the same as defined above.

Meanwhile, when preparing the transition metal compound represented by Formula 1 of the present invention, reaction may be performed by a process below.

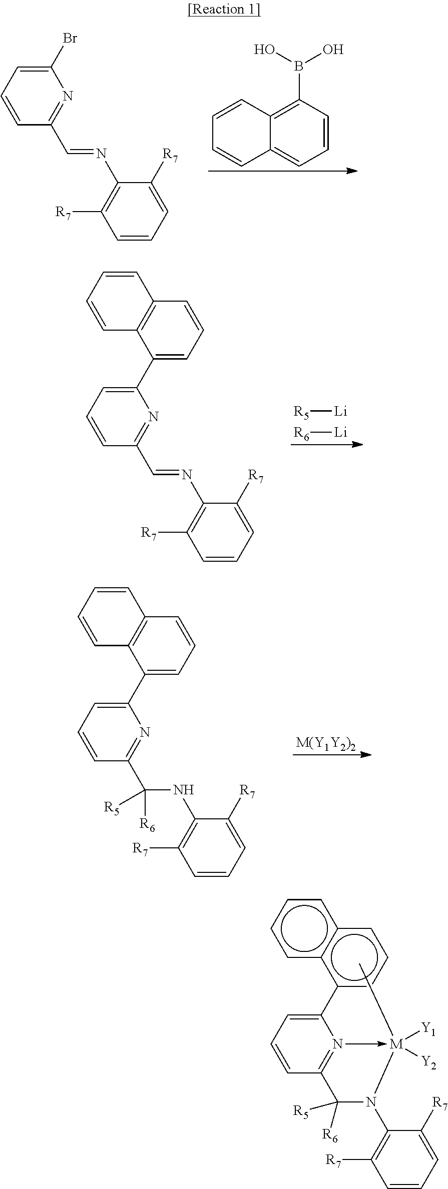

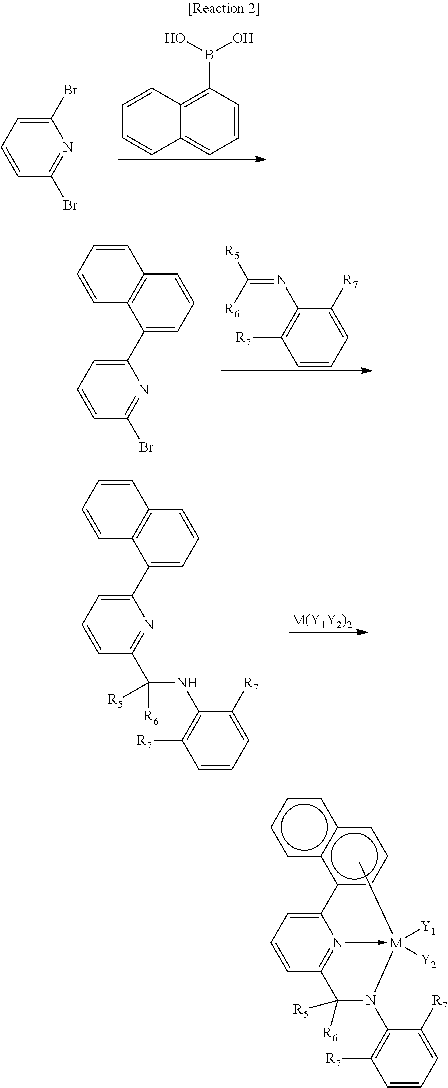

The catalyst composition of the present invention is characterized in including the transition metal compound represented by Formula 1 and a cocatalyst.

In the present invention, the “composition” includes a mixture of materials including a corresponding composition as well as a reaction product and decomposition product formed from the materials of the corresponding composition.

The cocatalyst may use any one well-known in the art, for example, one or more selected among the following Formulae 4 to 6 may be used as the cocatalyst:

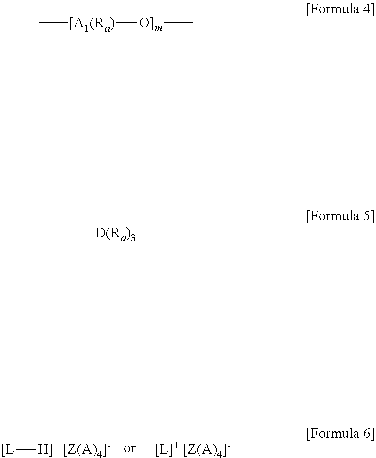

in the above formulae,
each Rₐ is independently a halogen radical; a hydrocarbyl radical of 1 to 20 carbon atoms; or a halogen-substituted hydrocarbyl radical of 1 to 20 carbon atoms,
m is an integer of 2 or more,
D is aluminum or boron,
L is a neutral or cationic Lewis acid,
Z is an element in group 13;
each A is independently an aryl group of 6 to 20 carbon atoms or an alkyl group of 1 to 20 carbon atoms, where one or more hydrogen atoms may be substituted with substituents; and
the substituent of A is a halogen group; a hydrocarbyl group of 1 to 20 carbon atoms; an alkoxy group of 1 to 20 carbon atoms; or an aryloxy group of 6 to 20 carbon atoms.

The compound represented by Formula 4 is not specifically limited as long is alkylaluminoxane. Preferable examples may include methylaluminoxane, ethylaluminoxane, isobutylaluminoxane, butylaluminoxane, etc., particularly preferably, methylaluminoxane.

The compound represented by Formula 5 is not specifically limited, and preferable examples thereof may include trimethylaluminum, triethylaluminum, triisobutylaluminum, tripropylaluminum, tributylaluminum, dimethylchloroaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, tributylboron, etc., and particularly preferably, be selected from trimethylaluminum, triethylaluminum, and triisobutylaluminum.

Examples of the compound represented by Formula 6, if Z is boron, may include, for example, dioctadecylmethylammonium tetrakis(pentafluorophenyl)borate [(C₁₈H₃₇)₂N(H)Me]⁺[B(C₆F₅)₄]⁻, dioctadecylmethylammonium, tetrakis(phenyl)borate, dioctadecylmethylammonium tetrakis[3,5-bis(trifluoromethyl)phenyl]borate, triethylammonium tetraphenylborate, tributylammonium tetraphenylborate, trimethylammonium tetraphenylborate, tripropylammonium tetraphenylborate, trimethylammonium tetra(p-tolyl)borate, trimethylammonium tetra(o,p-dimethylphenyl)borate, tributylammonium tetra(p-trifluoromethylphenyl)borate, trimethylammonium tetra(p-trifluoromethylphenyl)borate, tributylammonium tetrapentafluorophenylborate, N,N-diethylanilidium tetraphenylborate, N,N-diethylanilinium tetrapentafluorophenylborate, diethylammonium tetrapentafluorophenylborate, triphenylphosphonium tetraphenylborate, trimethylphosphonium tetraphenylborate, tripropylammonium tetra(p-tolyl)borate, triethylammonium tetra(o,p-dimethylphenyl)borate, trimethylammonium tetra(o,p-dimethylphenyl)borate, triphenylcarbonium tetra(p-trifluoromethylphenyl)borate, triphenylcarbonium tetrapentafluorophenylborate, or combinations thereof, if Z is aluminum, for example, triethylammonium tetraphenylaluminum, tributylammonium tetraphenylaluminum, trimethylammonium tetraphenylaluminum, tripropylammonium tetraphenylaluminum, trimethylammonium tetra(p-tolyl)aluminum, tripropylammonium tetra(p-tolyl)aluminum, triethylammonium tetra(o,p-dimethylphenyl)aluminum, tributylammonium tetra(p-trifluoromethylphenyl)aluminum, trimethylammonium tetra(p-trifluoromethylphenyl)aluminum, tributylammonium tetrapentafluorophenylaluminum, N, N-diethylanilinium tetraphenylaluminum, N, N-diethylanilinium tetrapentafluorophenylaluminum, diethylammonium tetrapentatetraphenylaluminum, triphenylphosphonium tetraphenylaluminum, trimethylphosphonium tetraphenylaluminum, triethylammonium tetraphenylaluminum, tributylammonium tetraphenylaluminum, or combinations thereof, without limitation.

Particularly, the cocatalyst used in the present invention may be the compound represented by Formula 6, particularly, dioctadecylmethylammonium tetrakis(pentafluorophenyl)borate.

In addition, the transition metal compound represented by Formula 1 and the cocatalyst may be used in a supported type by a support. Silica or alumina may be used as the support, without limitation.

The method for preparing an olefin polymer of the present invention is characterized in including a step of polymerizing an olefin monomer in the presence of the catalyst composition.

In the present invention, the “polymer” refers to a polymer compound prepared by polymerizing monomers of the same or different types. Such a general term of polymer includes the term of homopolymer used for referring to a polymer prepared from only one type of monomer and the term of interpolymer specified as follows.

In the present invention, the term “interpolymer” refers to a polymer prepared by polymerizing at least two different types of monomers. Like this, a general term of interpolymer refers to a polymer prepared from two different types of monomers and includes a commonly used copolymer and a polymer prepared from two or more different types of monomers.

In the present invention, the olefin monomer may be one or more selected from the group consisting of ethylene, propylene, 1-butene, 1-pentene, 4-methyl-1-pentene, 1-hexene, 1-heptene, 1-octene, 1-decene, 1-undecene, 1-dodecene, 1-tetradecene, 1-hexadecene and 1-eicosene, without limitation.

Particularly, the olefin polymer of the present invention may be an olefin homopolymer, or an olefin-alpha-olefin copolymer according to the type of the olefin monomer, and preferably, may be an ethylene/alpha-olefin copolymer. In this case, the amount of the alpha-olefin monomer, which is a comonomer, may be suitably selected according to the use, purpose, etc., of the olefin polymer by a person skilled in the art, and may be about 1 to 99 mol %.

The catalyst composition may be injected after being dissolved or diluted in an aliphatic hydrocarbon solvent of 5 to 12 carbon atoms such as pentane, hexane, heptane, nonane, decane, isomers thereof, an aromatic hydrocarbon solvent such as toluene and benzene, or a hydrocarbon solvent substituted with a chlorine atom such as dichloromethane and chlorobenzene, which are suitable for an olefin polymerization process. The solvent used herein may preferably be used after removing a small amount of water or air, which functions as a catalyst poison, by treating with a small amount of alkylaluminum, and may be treated by further using a cocatalyst.

The most preferable preparation process using the catalyst composition is a solution process, and if the composition is used together with an inorganic support such as silica, it may also be applied to a slurry process or a gas phase process.

The polymerization may be performed by homopolymerizing one type of olefin monomer or copolymerizing two or more olefin monomers by using one of a continuous slurry polymerization reactor, a loop slurry reactor, a gas phase reactor, or a solution reactor.

In addition, to remove moisture in the reactor during performing polymerization reaction, an organoaluminum compound may be further injected, and the polymerization reaction may be performed in the presence thereof. Particular examples of such organoaluminum compound may include trialkylaluminum, dialkylaluminum halide, alkylaluminum dihalide, aluminum dialkyl hydride or alkyl aluminum sesquihalide, and more particular examples thereof may include Al(C₂H₅)₃, Al(C₂H₅)₂H, Al(C₃H₇)₃, Al(C₃H₇)₂H, Al(i-C₄H₉)₂H, Al(C₈H₁₇)₃, Al(C₁₂H₂₅)₃, Al(C₂H₅)(C₁₂H₂₅)₂, Al(1-C₄H₉)(C₁₂H₂₅)₂, Al(i-C₄H₉)₂H, Al(i-C₄H₉)₃, (C₂H₅)₂AlCl, (i-C₃H₉)₂AlCl or (C₂H₅)₃Al₂Cl₃. Such an organoaluminum compound may be continuously injected to the reactor, or may be injected in a ratio of about 0.1 to 10 mol per 1 kg of a reaction medium which is injected to the reactor for suitable removal of moisture.

According to an embodiment of the present invention, the polymerization of the olefin polymer may be performed under conditions of a temperature of about 80 to 200° C., particularly, a temperature of about 90 to 200° C., or a temperature of about 130 to 200° C., and a pressure of about 20 to 100 bar, particularly, a pressure of about 20 to 50 bar, or a pressure of about 20 to 40 bar, for about 8 minutes to 2 hours.

### EXAMPLES

Hereinafter, the present invention will be explained in more detail referring to the examples. However, the examples are for illustrating the present invention, and the scope of the present invention is not limited thereto.

### Reagents and Experimental Conditions

All experiments were performed under an inert atmosphere using a standard glove box and Schlenk technique. Toluene, hexane, and tetrahydrofuran (THF) were used after distillation from benzophenone ketyl. Methylcyclohexane (anhydrous grade) used in polymerization reaction was used after purchasing from Tokyo Chemical Industry (TCI) and purifying using a Na/K alloy. HfCl₄ of a sublimation grade was purchased from Streme and used as it was. An ethylene-propylene gas mixture was purified with trioctylaluminum (0.6 M in a mineral system) in a bomb reactor (2.0 L) and used.

¹H NMR (600 MHz) and ¹³C NMR (150 MHz) spectrums were recorded using a ECZ 600 apparatus (JOEL).

Elemental analysis was performed in the Analysis Center of Ajou University.

GPC data was analyzed in 1,2,4-trichlorobenzene at 160° C. using a PL-GPC 220 system equipped with a refractive index detector and two columns (Plarian Mixed-B 7.5×300 mm Varian [Polymer Lab]).

### Preparation of Transition Metal Compound

### Example 1

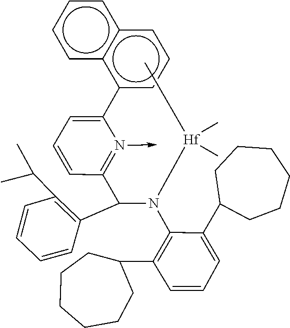

### (i) Preparation of Ligand Compound

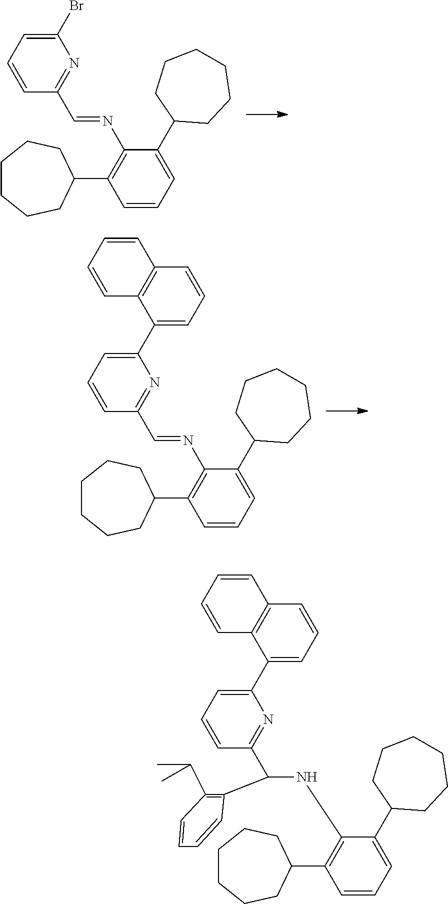

2,6-dicycloheptylaniline (1.94 g, 6.78 mmol) and 6-bromo-2-pyridinecarboxaldehyde (1.26 g, 6.78 mmol) were dissolved in toluene (8 mL), and molecular sieves were injected thereto. The mixture was heated to 70° C. overnight while stirring. After filtering, a solvent was removed in a rotary evaporator. A yellow solid was obtained (2.35 g, 77%).

¹H NMR (C₆D₆): δ 8.42 (s, 1H, NCH), 8.11 (d, J=6.6 Hz, 1H), 7.14 (m, 3H), 6.84 (d, J=8.4 Hz, 1H), 6.64 (t, J=7.2 Hz, 1H), 2.94 (m, 2H), 1.92 (m, 4H), 1.62 (m, 8H), 1.45 (m, 12H) ppm.

¹³C NMR (C₆D₆): δ 27.79, 28.21, 36.54, 40.95, 119.38, 124.24, 125.36, 129.83, 138.79, 138.82, 142.56, 147.48, 156.00, 162.28 ppm.

HRMS (EI): m/z calcd. ([M⁺] C₂₆H₃₃BrN₂) 452.1827. Found: 452.1830.

Under nitrogen, a Schlenk flask was charged with the compound (2.35 g, 5.18 mmol), 1-naphthylboronic acid (0.936 g, 5.44 mmol), Na₂CO₃ (1.45 g, 13.6 mmol) and toluene (10 mL). A solution of (Ph₃P)₄Pd (16.2 mg, 0.0140 mmol) in a degassed H₂O-EtOH mixture (1:1 [v/v], 5 mL) and toluene (2 mL) was injected. A two-phase solution was heated to 70° C. overnight while stirring. After cooling to room temperature, water (15 mL) was added, and a product was extracted with toluene (3×10 mL). An organic phase collected was dried with anhydrous MgSO₄, and solvents were removed in a rotary evaporator. A yellow solid was obtained (2.17 g, 84%).

¹H NMR (C₆D₆): δ 8.70 (s, 1H, NCH), 8.44 (d, J=7.8 Hz, 1H), 8.35 (d, J=9.0 Hz, 1H), 7.68 (d, J=7.2 Hz, 1H), 7.65 (d, J=8.4 Hz, 1H), 7.53 (d, J=7.2 Hz, 1H), 7.28 (m, 4H), 7.18 (m, 4H), 3.11 (m, 2H), 2.00 (m, 4H), 1.66 (m, 8H), 1.52 (m, 12H) ppm.

¹³C NMR (C₆D₆): δ 27.87, 28.23, 36.66, 40.94, 119.14, 124.22, 125.13, 125.49, 126.16, 126.27, 126.61, 126.73, 128.35, 128.74, 129.39, 131.83, 134.54, 137.18, 138.54, 139.06, 147.97, 155.11, 159.84, 164.29 ppm.

HRMS (EI): m/z calcd. ([M⁺] C₃₆H₄₀N₂) 500.3191. Found: 500.3188.

2-isopropylphenyllithium (0.436 g, 3.46 mmol) dissolved in diethyl ether (8 mL) was added dropwisely to a Schlenk flask including the compound (1.00 g, 2.00 mmol) in diethyl ether (20 mL). After stirring for 3 hours, an aqueous solution (10 mL) of ammonium chloride (0.30 g) was added thereto, and a product was extracted with diethyl ether (3×10 mL). An oil produced was dried overnight at 60° C. in high vacuum. A yellow solid was obtained (0.912 g, 74%).

¹H NMR (C₆D₆): δ 8.24 (m, 1H), 7.82 (m, 1H), 7.63 (m, 1H), 7.61 (d, J=8.4 Hz, 1H), 7.56 (d, J=7.2 Hz, 1H), 7.23 (m, 8H), 7.11 (m, 4H), 5.72 (s, 1H, NCH), 4.46 (s, 1H, NH), 3.27 (septet, J=7.2 Hz, 1H, CH), 2.89 (m, 2H), 1.82 (m, 2H), 1.74 (m, 2H), 1.58 (m, 8H), 1.39 (m, 8H), 1.24 (m, 2H), 1.14 (m, 2H), 1.00 (d, J=6.6 Hz, 3H, CH₃), 0.98 (d, J=6.0 Hz, 3H, CH₃) ppm.

¹³C NMR (C₆D₆): δ 23.60, 24.53, 27.83, 27.95, 27.98, 29.10, 37.22, 37.50, 40.34, 67.23, 119.93 122.91, 124.31, 124.59, 125.34, 125.77, 126.03, 126.53, 126.58, 126.72, 127.56, 128.53, 129.34, 131.84, 134.63, 136.97, 138.74, 142.09, 142.95, 144.24, 146.46, 159.23, 164.01 ppm.

HRMS (EI): m/z calcd. ([M⁺] C₄₅H₅₂N₂) 620.4130. Found: 620.4128.

### (ii) Preparation of Transition Metal Compound

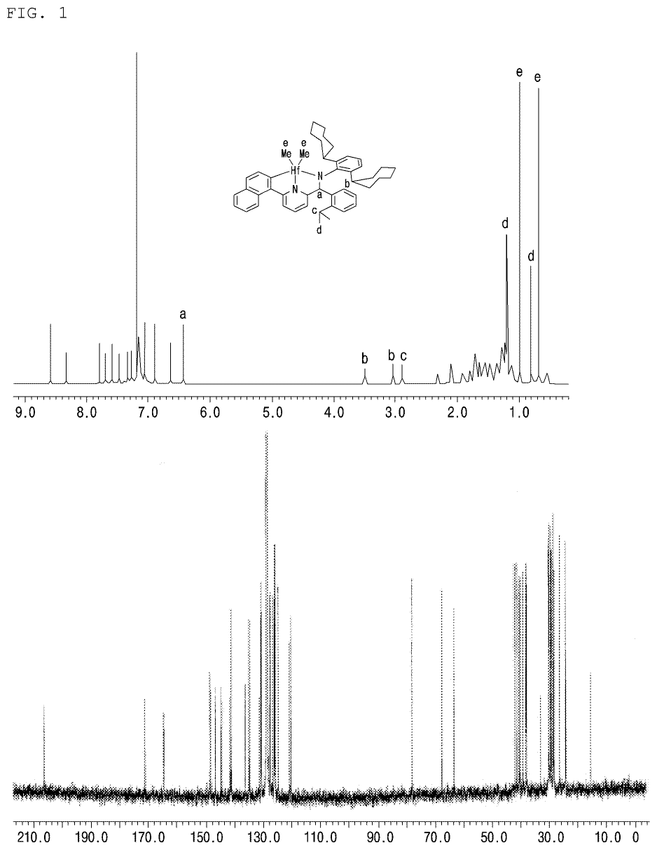

A Schlenk flask was charged with the ligand compound (0.241 g, 0.388 mmol) in toluene (1.5 g), and n-BuLi (0.25 mL, a 1.6 M solution in hexane, 0.41 mmol) was added thereto dropwisely at room temperature. After stirring for 1 hour, HfCl₄ (0.125 g, 0.390 mmol) was added thereto as a solid. The reaction mixture was heated at 100° C. and stirred for 2 hours. After cooling, MeMgBr (0.44 mL, a 3.1 M solution in diethyl ether, 1.4 mmol) was injected, followed by stirring at room temperature overnight. A volatile material was removed via a vacuum line, and a product was extracted with toluene (12 mL). The extract was obtained through celite filtering. After removing a solvent through a vacuum line, the residue was softened in hexane (2 mL) to obtain a yellow solid (0.211 g, 66%). ¹H NMR spectrum and ¹³C NMR spectrum were analyzed, and the results are shown in FIG. 1.

¹H NMR (C₆D₆): δ 8.59 (d, J=7.2 Hz, 1H), 8.34 (d, J=8.4 Hz, 1H), 7.78 (d, J=8.4 Hz, 1H), 7.69 (d, J=6.6 Hz, 1H), 7.58 (d, J=7.2 Hz, 1H), 7.47 (m, 1H), 7.32 (m, 1H), 7.27 (t, J=7.2 Hz, 1H), 7.18 (m, 1H), 7.09 (m, 5H), 6.90 (d, J=7.8 Hz, 1H), 6.64 (d, J=7.8 Hz, 1H), 6.44 (s, 1H, NCH), 3.49 (m, 1H), 3.04 (t, J=10.2 Hz, 1H), 2.89 (septet, J=7.2 Hz, 1H, CH), 2.32 (m, 1H), 2.10 (m, 2H), 1.90 (m, 1H), 1.80 (m, 1H), 1.62 (m, 10H), 1.24 (m, 6H), 1.19 (d, J=7.2 Hz, 3H, CH₃), 1.13 (m, 2H), 0.98 (s, 3H, HfCH₃), 0.79 (d, J=6.6 Hz, 3H, CH₃), 0.69 (s, 3H, HfCH₃), 0.56 (m, 1H) ppm.

¹³C NMR (C₆D₆): δ 23.17, 25.27, 27.17, 27.45, 27.50, 27.62, 28.15, 28.37, 28.89, 28.93, 29.20, 37.01, 38.22, 39.24, 39.57, 40.30, 41.05, 62.44, 66.71, 77.22, 119.61, 120.23, 124.18, 125.30, 125.43, 125.51, 126.04, 126.97, 127.14, 129.94, 130.04, 130.20, 130.85, 134.31, 135.81, 140.70, 141.02, 143.95, 144.35, 146.27, 147.83, 148.19, 164.39, 171.96, 206.43 ppm.

Anal. calcd. (C₄₇H₅₆HfN₂): C, 68.22; H, 6.82; N, 3.39%. Found: C, 68.44; H, 6.95; N, 3.07%.

### Example 2

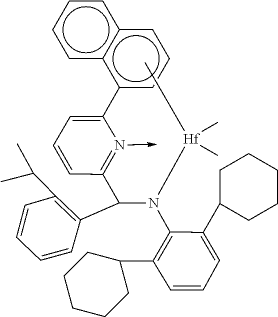

### (i) Preparation of Ligand Compound

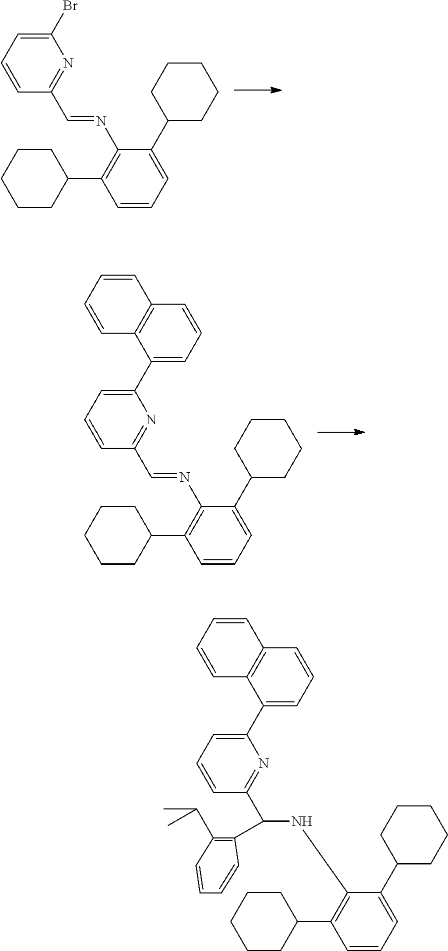 [SMILES: Brc1cccc(/C=N/c2c(C3CCCCC3)cccc2C2CCCCC2)n1 ; C(=N\c1c(C2CCCCC2)cccc1C1CCCCC1)/c1cccc(-c2cccc3ccccc23)n1 ; CC(C)c1ccccc1[C@H](Nc1c(C2CCCCC2)cccc1C1CCCCC1)c1cccc(-c2cccc3ccccc23)n1]

Preparation was performed by the same method as in Example 1 using 2,6-dicyclohexylaniline (0.772 g, 3.00 mmol), 6-bromo-2-pyridinecarboxaldehyde (0.558 g, 3.00 mmol) and toluene (5 mL). A yellow solid was obtained (1.07 g, 84%).

¹H NMR (C₆D₆): δ 8.41 (s, 1H, NCH), 8.09 (d, J=7.8 Hz, 1H), 7.53 (m, 3H), 6.85 (d, J=7.8 Hz, 1H), 6.63 (t, J=7.8 Hz, 1H), 2.74 (m, 2H), 1.87 (d, J=12 Hz, 4H), 1.64 (d, J=12.6 Hz, 4H), 1.54 (d, J=10.8 Hz, 2H), 1.39 (quartet, J=10.2 Hz, 4H), 1.11 (m, 6H) ppm.

¹³C NMR (C₆D₆): δ 26.55, 27.33, 34.25, 39.30, 119.42, 124.32, 125.21, 129.83, 136.68, 138.82, 142.54, 148.94, 155.95, 162.06 ppm.

HRMS (EI): m/z calcd ([M⁺] C₂₄H₂₉BrN₂) 424.1514. Found: 424.1516.

Preparation was performed by the same method as in Example 1 using the compound (1.07 g, 2.51 mmol), 1-naphthylboronic acid (0.453 g, 2.64 mmol), Na₂CO₃ (0.700 g, 6.60 mmol), toluene (5 mL), degassed H₂O/EtOH (1 mL, v/v, 1:1), and (Ph₃P)₄Pd (7.83 mg, 0.00678 mmol) in toluene (1 mL). By column chromatography on silica gel using hexane and ethyl acetate containing a small amount of triethylamine (v/v, 90:3:1), a lemon yellow oil (0.712 g, 60%) was obtained.

¹H NMR (C₆D₆): δ 8.70 (s, 1H, NCH), 8.41 (d, J=7.8 Hz, 1H), 8.31 (d, J=7.8 Hz, 1H), 7.68 (d, J=7.2 Hz, 1H), 7.65 (d, J=7.8 Hz, 1H), 7.54 (d, J=7.2 Hz, 1H), 7.27 (m, 4H), 7.20 (m, 4H), 2.93 (m, 2H), 1.90 (d, J=12 Hz, 4H), 1.61 (d, J=13.2 Hz, 4H), 1.50 (d, J=12.6 Hz, 2H), 1.38 (m, 4H), 1.11 (m, 6H), ppm.

¹³C NMR (C₆D₆): δ 26.63, 27.38, 34.35, 39.36, 119.21, 124.32, 124.98, 125.50, 126.15, 126.21, 126.64, 126.75, 128.15, 128.73, 129.38, 131.81, 134.52, 136.94, 137.14, 138.52, 149.48, 155.13, 159.79, 164.05 ppm.

HRMS (EI): m/z calcd ([M⁺] C₃₄H₃₆N₂) 472.2878. Found: 472.2878.

Preparation was performed by the same method as in Example 1 using the compound (0.247, 0.523 mmol) and 2-isopropylphenyllithium (0.114 g, 0.904 mmol). A yellow solid was obtained (0.257 g, 83%).

¹H NMR (C₆D₆): δ 8.24 (m, 1H), 7.90 (m, 1H), 7.64 (m, 1H), 7.62 (d, J=7.8 Hz, 1H), 7.56 (d, J=7.2 Hz, 1H), 7.26 (m, 3H), 7.22 (m, 4H), 7.11 (m, 5H), 5.62 (d, J=5.4 Hz, 1H, NCH), 4.59 (d, J=5.4 Hz, 1H, NH), 3.31 (septet, J=7.2 Hz, 1H, CH), 2.74 (m, 2H), 1.79 (d, J=7.8 Hz, 2H), 1.64 (m, 4H), 1.54 (m, 4H), 1.32 (m, 4H), 1.08 (m, 2H), 1.03 (d, J=6.6 Hz, 3H, CH₃), 1.00 (m, 1H), 0.980 (d, J=6.6 Hz, 3H, CH₃), 0.921 (m, 3H) ppm.

¹³C NMR (C₆D₆): δ 23.78, 24.45, 26.63, 27.42, 27.54, 28.96, 34.77, 35.08, 39.01, 67.64, 119.99, 122.89, 124.13, 124.80, 125.36, 125.77, 126.08, 126.46, 126.56, 126.71, 127.58, 128.55, 129.35, 131.84, 134.64, 136.94, 138.77, 141.88, 142.24, 144.97, 146.32, 159.28, 163.74 ppm.

HRMS (EI): m/z calcd ([M⁺] C₄₃H₄₈N₂) 592.3817. Found: 592.3819.

### (ii) Preparation of Transition Metal Compound

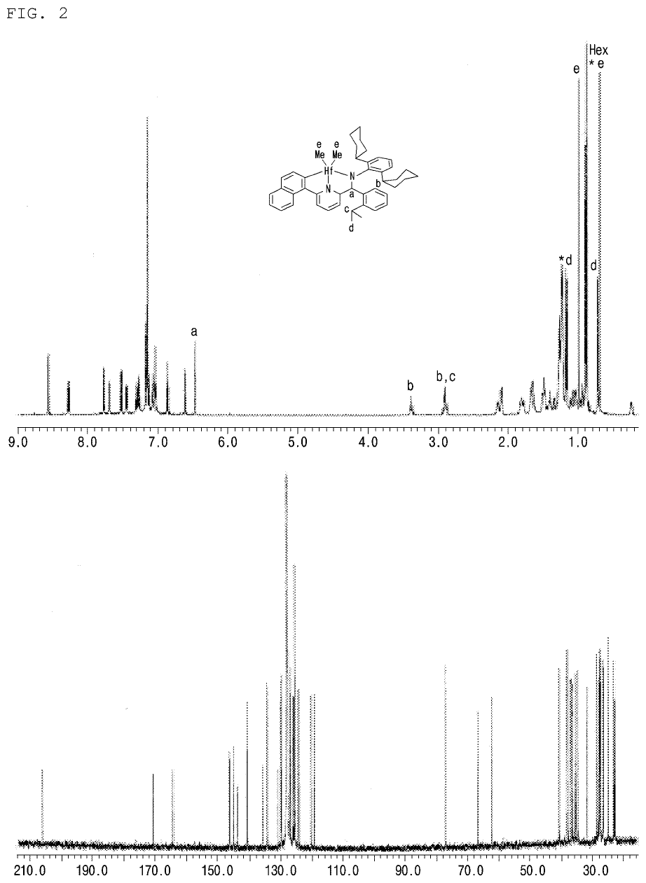

Preparation was performed by the same method as in Example 1 using the ligand compound (0.150 g, 0.253 mmol), n-BuLi (0.17 mL, a 1.6 M solution in hexane, 0.27 mmol), HfCl₄ (0.0814 g, 0.254 mmol), MeMgBr (0.29 mL, a 3.1 M solution in diethyl ether, 0.89 mmol) and toluene (1.5 g). A yellow solid was obtained (0.128 g, 63%). ¹H NMR spectrum and ¹³C NMR spectrum were analyzed, and the results are shown in FIG. 2.

¹H NMR (C₆D₆): δ 8.58 (d, J=7.8 Hz, 1H), 8.29 (d, J=8.4 Hz, 1H), 7.79 (d, J=7.8 Hz, 1H), 7.71 (d, J=7.2 Hz, 1H), 7.54 (d, J=7.8 Hz, 1H), 7.46 (m, 1H), 7.30 (m, 2H), 7.15 (m, 3H), 7.09 (m, 3H), 6.88 (t, J=7.8 Hz, 1H), 6.62 (d, J=8.4 Hz, 1H), 6.48 (s, 1H, NCH), 3.39 (m, 1H), 2.92 (m, 2H), 2.15 (d, J=13.8 Hz, 1H), 2.10 (d, J=13.8 Hz, 2H), 1.80 (m, 2H), 1.65 (m, 3H), 1.29 (m, 6H), 1.17 (d, J=7.2 Hz, 3H, CH₃), 1.07 (m, 3H), 0.99 (s, 3H, HfCH₃), 0.95 (m, 2H), 0.73 (d, J=7.2 Hz, 3H, CH₃), 0.70 (s, 3H, HfCH₃), 0.23 (m, 1H) ppm.

¹³C NMR (C₆D₆): δ 23.31, 25.04, 26.63, 26.74, 27.70, 27.76, 27.81, 28.29, 28.89, 35.00, 35.66, 36.62, 37.02, 38.13, 40.88, 62.53, 67.00, 77.27, 119.30, 120.30, 124.29, 125.52, 125.60, 125.97, 126.95, 127.06, 127.73, 129.91, 130.00, 130.09, 130.85, 134.36, 135.80, 140.73, 140.89, 144.02, 145.12, 146.31, 146.38, 146.49, 164.46, 170.79, 206.40 ppm.

Anal. calcd. (C₄₅H₅₂HfN₂): C, 67.61; H, 6.56; N, 3.50%. Found: C, 67.98; H, 6.88; N, 3.19%.

### Example 3

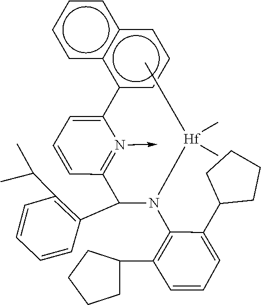

### (i) Preparation of Ligand Compound

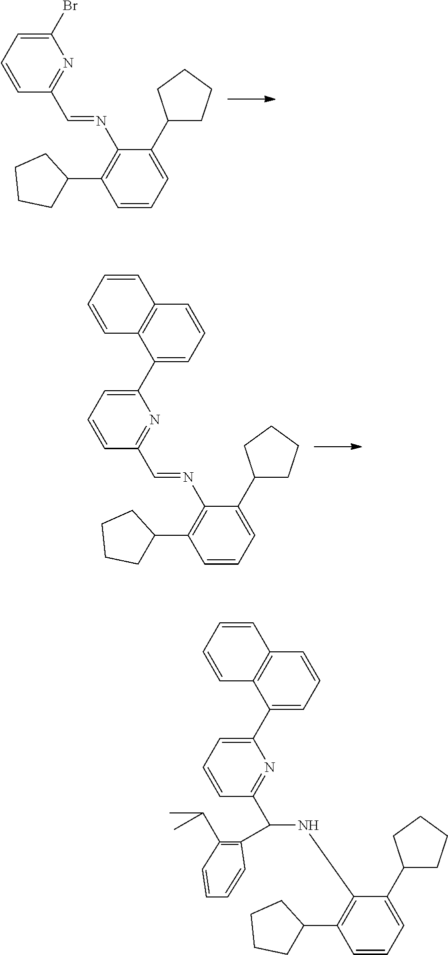 [SMILES: Brc1cccc(/C=N/c2c(C3CCCC3)cccc2C2CCCC2)n1 ; C(=N\c1c(C2CCCC2)cccc1C1CCCC1)/c1cccc(-c2cccc3ccccc23)n1 ; CC(C)c1ccccc1[C@H](Nc1c(C2CCCC2)cccc1C1CCCC1)c1cccc(-c2cccc3ccccc23)n1]

Preparation was performed by the same method as in Example 1 using 2,6-dicyclopentylaniline (1.69 g, 7.36 mmol), 6-bromo-2-pyridinecarboxaldehyde (1.37 g, 7.36 mmol) and toluene (12 mL). A yellow solid was obtained (1.07 g, 84%). Through recrystallization in hexane and toluene at −30° C., an analytically pure compound was obtained.

¹H NMR (C₆D₆): δ 8.36 (s, 1H, NCH), 8.03 (d, J=7.8 Hz, 1H), 7.13 (m, 3H), 6.84 (d, J=7.8 Hz, 1H), 6.60 (t, J=7.2 Hz, 1H), 3.13 (m, 2H), 1.91 (m, 4H), 1.59 (m, 8H), 1.40 (m, 4H) ppm. ¹³C NMR (C₆D₆): δ 26.05, 34.72, 40.82, 119.55, 124.11, 125.21, 129.78, 135.28, 138.79, 142.45, 150.38, 155.90, 162.32 ppm.

HRMS (EI): m/z calcd ([M⁺] C₂₂H₂₅BrN₂) 396.1201. Found: 396.1203.

Preparation was performed by the same method as in Example 1 using the compound (1.63 g, 4.09 mmol), 1-naphthylboronic acid (0.739 g, 4.30 mmol), Na₂CO₃ (1.14 g, 10.8 mmol), toluene (8 mL), degassed H₂O/EtOH (3.5 mL, v/v, 1:1), and a solution of (Ph₃P)₄Pd (12.8 mg, 0.0111 mmol) in toluene (1 mL). Through recrystallization in hexane and toluene at −30° C., an analytically pure compound was obtained. A yellow solid was obtained (1.24 g, 68%).

¹H NMR (C₆D₆): δ 8.66 (s, 1H, NCH), 8.39 (d, J=7.2 Hz, 1H), 8.28 (m, 1H), 7.68 (m, 1H), 7.65 (d, J=8.4 Hz, 1H), 7.56 (d, J=7.2 Hz, 1H), 7.24 (m, 6H), 7.17 (s, 1H), 7.14 (d, J=8.4 Hz, 1H), 3.30 (quintet, d, J=7.2 Hz, 2H), 2.00 (m, 4H), 1.64 (m, 8H), 1.44 (m, 4H) ppm.

¹³C NMR (C₆D₆): δ 26.07, 34.78, 40.94, 119.31, 124.12, 124.98, 125.53, 126.16, 126.18, 126.65, 126.77, 128.74, 129.38, 131.79, 134.51, 135.47, 137.07, 138.57, 150.98, 155.14, 159.73, 164.32 ppm.

HRMS (EI): m/z calcd ([M⁺] C₃₂H₃₂N₂) 444.2565. Found: 444.2561.

Preparation was performed by the same method as in Example 1 using the compound (1.20, 2.70 mmol) and 2-isopropylphenyllithium (0.589 g, 4.66 mmol). A lemon yellow solid was obtained (1.38 g, 91%).

¹H NMR (C₆D₆): δ 8.22 (m, 1H), 7.77 (d, J=8.4 Hz, 1H), 7.65 (m, 1H), 7.61 (d, J=8.4 Hz, 1H), 7.53 (d, J=7.2 Hz, 1H), 7.27 (m, 3H), 7.19 (m, 1H), 7.13 (m, 6H), 7.07 (d, J=7.8 Hz, 1H), 7.03 (d, J=7.2 Hz, 1H), 5.74 (s, 1H, NCH), 4.95 (s, 1H, NH), 3.34 (septet, J=7.2 Hz, 1H, CH), 3.26 (m, 2H), 1.87 (m, 2H), 1.71 (m, 2H), 1.61 (m, 4H), 1.48 (m, 4H), 1.32 (m, 4H), 1.03 (d, J=6.6 Hz, 3H, CH₃), 0.981 (d, J=6.6 Hz, 3H, CH₃) ppm.

¹³C N-MR (C₆D₆): δ 23.83, 24.39, 26.06 26.08, 28.94, 35.54, 35.62, 40.58, 67.19, 120.19, 122.87, 124.25, 124.69, 125.39, 125.89, 126.10, 126.30, 126.58, 126.60, 127.65, 128.59, 128.63, 129.31, 131.86, 134.60, 136.86, 138.87, 140.76, 141.40, 145.93, 146.72, 159.08, 163.23 ppm.

HRMS (EI): m/z calcd ([M⁺] C₄₁H₄₄N₂) 564.3504. Found: 564.3507.

### (ii) Preparation of Transition Metal Compound

Preparation was performed by the same method as in Example 1 using the ligand compound (0.300 g, 0.531 mmol), n-BuLi (0.348 mL, a 1.6 M solution in hexane, 0.560 mmol), HfCl₄ (0.171 g, 0.533 mmol), MeMgBr (0.60 mL, a 3.1 M solution in diethyl ether, 1.9 mmol) and toluene (3.0 g). A yellow solid was obtained (0.278 g, 68%).

¹H NMR (C₆D₆): δ 8.59 (d, J=7.8 Hz, 1H), 8.24 (d, J=8.4 Hz, 1H), 7.81 (d, J=7.2 Hz, 1H), 7.71 (d, J=7.8 Hz, 1H), 7.47 (d, J=8.4 Hz, 1H), 7.30 (m, 3H), 7.21 (m, 2H), 7.11 (m, 2H), 7.01 (m, 2H), 6.80 (t, J=7.8 Hz, 1H), 6.62 (s, 1H, NCH), 6.52 (d, J=7.8 Hz, 1H), 3.74 (m, 1H), 3.55 (quintet, J=8.4 Hz, 1H), 2.90 (septet, J=6.6 Hz, 1H, CH), 2.38 (m, 1H), 2.28 (m, 1H), 2.13 (m, 1H), 1.69 (m, 8H), 1.29 (m, 3H), 1.19 (d, J=7.2 Hz, 3H, CH₃), 1.04 (m, 1H), 0.92 (s, 3H, HfCH₃), 0.72 (d, J=6.6 Hz, 3H, CH₃), 0.70 (s, 3H, HfCH₃), 0.29 (m, 1H) ppm.

¹³C NMR (C₆D₆): δ 23.22, 25.23, 26.23, 26.31, 27.15, 27.45, 28.66, 36.27, 37.46, 38.06, 38.54, 40.40, 41.01, 62.13, 66.83, 119.52, 120.37, 124.24, 125.09, 125.26, 125.51, 125.61, 125.86, 126.17, 126.50, 126.63, 126.95, 129.88, 129.97, 130.00, 130.78, 134.11, 134.30, 135.73, 140.79, 140.87, 144.06, 144.80, 145.93, 146.96, 146.99, 164.46, 170.79, 206.11 ppm.

Anal. calcd. (C₄₃H₄₈HfN₂): C, 66.96; H, 6.27; N, 3.63%. Found: C, 67.12; H, 6.59; N, 3.42%.

### Example 4

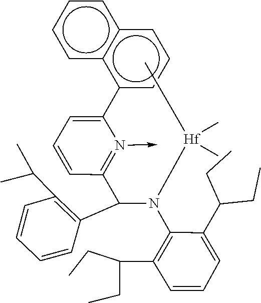

### (i) Preparation of Ligand Compound

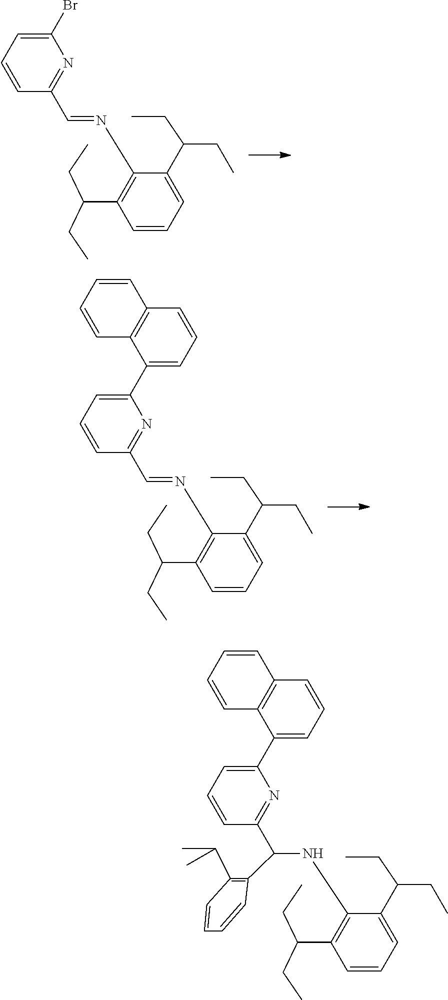

Preparation was performed by the same method as in Example 1 using 2,6-di(3-pentyl) aniline (2.2 g, 9.42 mmol), 6-bromo-2-pyridinecarboxaldehyde (1.75 g, 9.42 mmol) and toluene (15 mL). A yellow solid was obtained (3.30 g, 87%).

¹H NMR (C₆D₆): δ 8.42 (s, 1H, NCH), 8.03 (d, J=7.2 Hz, 1H), 7.11 (m, 1H), 7.03 (d, J=7.8 Hz, 2H), 6.89 (d, J=8.4 Hz, 1H), 6.66 (t, J=8.4 Hz, 1H), 2.66 (quintet, J=7.8 Hz, 2H), 1.54 (quintet, J=7.2 Hz, 8H, CH₂), 0.80 (t, J=7.2 Hz, 12H, CH₃) ppm.

¹³C NMR (C₆D₆): δ 12.37, 29.61, 42.74, 119.42, 124.35, 125.20, 129.79, 134.12, 138.81, 142.50, 151.86, 155.93, 162.63 ppm.

HRMS (EI): m/z calcd ([M⁺] C₂₂H₂₉BrN₂) 400.1514. Found: 400.1512.

Preparation was performed by the same method as in Example 1 using the compound (1.06 g, 2.63 mmol), 1-naphthylboronic acid (0.475 g, 2.76 mmol), Na₂CO₃ (0.733 g, 6.92 mmol), toluene (5 mL), degassed H₂O/EtOH (2.3 mL, v/v, 1:1), and a solution of (Ph₃P)₄Pd (8.21 mg, 0.0711 mmol) in toluene (1 mL). A yellow solid was obtained (1.00 g, 85%).

¹H NMR (C₆D₆): δ 8.71 (s, 1H, NCH), 8.37 (d, J=7.2 Hz, 1H), 8.31 (m, 1H), 7.67 (t, J=4.2 Hz, 1H), 7.65 (d, J=8.4 Hz, 1H), 7.58 (d, J=7.2 Hz, 1H), 7.28 (m, 4H), 7.21 (d, J=7.8 Hz, 1H), 7.14 (d, J=7.2 Hz, 1H), 7.07 (d, J=7.8 Hz, 2H), 2.84 (quintet, J=6.6 Hz, 2H, CH), 1.60 (quintet, J=7.8 Hz, 8H, CH₂), 0.867 (t, J=7.2 Hz, 12H, CH₃) ppm.

¹³C NMR (C₆D₆): δ 12.44, 29.69, 42.80, 119.18, 124.33, 124.96, 125.53, 126.17, 126.66, 126.75, 128.21, 128.73, 129.37, 131.79, 134.34, 134.51, 137.05, 138.58, 152.45, 155.10, 159.75, 164.66 ppm.

HRMS (EI): m/z calcd ([M⁺] C₃₂H₃₆N₂) 448.2878. Found: 448.2881.

Preparation was performed by the same method as in Example 1 using the compound (0.763 g, 1.70 mmol) and 2-isopropylphenyllithium (0.371 g, 2.94 mmol). A lemon yellow solid was obtained (0.878 g, 91%).

¹H NMR (C₆D₆): δ 8.28 (m, 1H), 7.70 (d, J=7.8 Hz, 1H), 7.64 (m, 1H), 7.61 (d, J=8.4 Hz, 1H), 7.52 (d, J=7.8 Hz, 1H), 7.27 (m, 3H), 7.18 (m, 4H), 7.11 (m, 3H), 7.01 (d, J=7.8 Hz, 2H), 5.72 (d, J=7.8 Hz, 1H, NCH), 4.83 (d, J=7.8 Hz, 1H, NH), 3.37 (septet, J=6.6 Hz, 1H, CH), 2.81 (m, 2H), 1.60 (d, J=7.2 Hz, 2H, CH₂), 1.54 (d, J=7.2 Hz, 2H, CH₂), 1.41 (d, J=7.2 Hz, 2H, CH₂), 1.32 (d, J=7.2 Hz, 2H, CH₂), 1.01 (d, J=6.6 Hz, 3H, CH₃), 0.940 (d, J=6.6 Hz, 3H, CH₃), 0.793 (t, J=6.6 Hz, 6H, CH₃), 0.700 (t, J=6.6 Hz, 6H, CH₃) ppm.

¹³C NMR (C₆D₆): δ 12.22, 12.41, 23.80, 24.42, 28.98, 29.41, 29.72, 42.01, 67.19, 120.14, 122.83, 124.31, 125.32, 126.04, 126.42, 126.59, 126.72, 127.67, 128.55, 128.74, 129.36, 131.89, 134.63, 136.96, 138.74, 140.66, 141.51, 146.78, 146.85, 159.04, 163.40 ppm.

HRMS (EI): m/z calcd ([M⁺] C₄₁H₄₈N₂) 568.3817. Found: 568.3820.

### (ii) Preparation of Transition Metal Compound

Preparation was performed by the same method as in Example 1 using the ligand compound (0.205 g, 0.361 mmol), n-BuLi (0.24 mL, a 1.6 M solution in hexane, 0.38 mmol), HfCl₄ (0.116 g, 0.362 mmol), MeMgBr (0.41 mL, a 3.1 M solution in diethyl ether, 1.3 mmol) and toluene (2.0 g). A dark yellow solid was obtained (0.167 g, 60%).

¹H NMR (C₆D₆): δ 8.61 (d, J=7.8 Hz, 1H), 8.28 (d, J=8.4 Hz, 1H), 7.81 (d, J=7.8 Hz, 1H), 7.72 (d, J=8.4 Hz, 1H), 7.50 (m, 2H), 7.31 (m, 2H), 7.12 (m, 3H), 7.05 (m, 3H), 6.84 (t, J=7.8 Hz, 1H), 6.62 (d, J=8.4 Hz, 1H), 6.53 (s, 1H, NCH), 3.55 (m, 1H, CH), 2.92 (septet, J=7.2 Hz, 1H, CH), 2.76 (m, 1H, CH), 1.94 (m, 1H), 1.77 (m, 5H), 1.48 (m, 1H), 1.18 (d, J=6.6 Hz, 3H, CH₃), 1.05 (t, J=7.8 Hz, 3H, CH₃), 1.02 (s, 3H, HfCH₃), 0.98 (t, J=7.2 Hz, 3H, CH₃), 0.80 (m, 6H, HfCH₃, CH₃), 0.73 (t, J=7.8 Hz, 3H, CH₃), 0.56 (m, 4H) ppm.

¹³C NMR (C₆D₆): δ 11.31, 12.37, 13.39, 13.58, 23.35, 25.33, 27.89, 28.25, 28.77, 31.11, 39.90, 43.27, 63.34, 67.51, 77.52, 119.33, 120.26, 124.25, 124.95, 125.49, 125.53, 125.67, 125.79, 126.93, 127.02, 129.92, 129.99, 130.18, 130.78, 134.48, 135.74, 140.77, 141.35, 143.89, 144.80, 144.89, 146.21, 147.87, 164.29, 170.75, 205.95 ppm.

Anal. calcd. (C₄₃H₅₂HfN₂): C, 66.61; H, 6.76; N, 3.61%. Found: C, 66.54; H, 6.88; N, 3.80%.

### Example 5

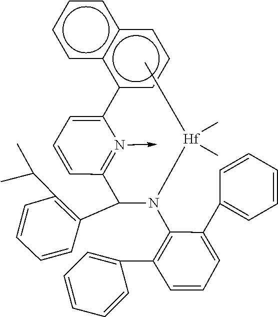

### (i) Preparation of Ligand Compound

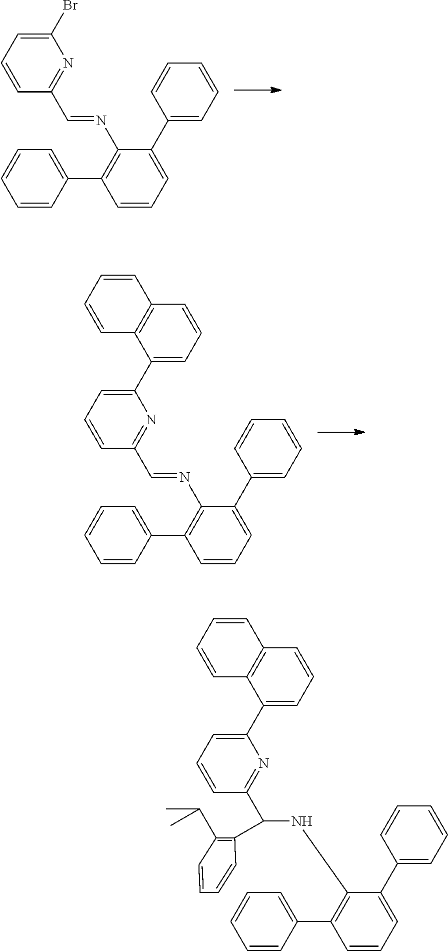 [SMILES: Brc1cccc(/C=N/c2c(-c3ccccc3)cccc2-c2ccccc2)n1 ; C(=N\c1c(-c2ccccc2)cccc1-c1ccccc1)/c1cccc(-c2cccc3ccccc23)n1 ; CC(C)c1ccccc1[C@H](Nc1c(-c2ccccc2)cccc1-c1ccccc1)c1cccc(-c2cccc3ccccc23)n1]

Preparation was performed by the same method as in Example 1 using 2,6-diphenylaniline (2.00 g, 8.15 mmol), 6-bromo-2-pyridinecarboxaldehyde (1.52 g, 8.15 mmol) and toluene (10 mL).

¹H NMR (C₆D₆): δ 8.09 (s, 1H, NCH), 7.63 (d, J=7.8 Hz, 1H), 7.38 (d, J=7.2 Hz, 4H), 7.29 (d, J=7.8 Hz, 2H), 7.07 (m, 5H), 6.97 (t, J=7.8 Hz, 2H), 6.64 (d, J=7.2 Hz, 1H), 6.42 (t, J=7.2 Hz, 1H) ppm.

¹³C NMR (C₆D₆): δ 119.44, 125.53, 127.06, 128.34, 129.47, 130.42, 130.46, 133.86, 138.36, 140.34, 142.02, 148.13, 155.59, 164.42 ppm.

HRMS (EI): m/z calcd ([M⁺] C₂₄H₁₇BrN₂) 412.0575. Found: 412.0572.

Preparation was performed by the same method as in Example 1 using the compound (2.08 g, 5.04 mmol), 1-naphthylboronic acid (0.910 g, 5.29 mmol), Na₂CO₃ (1.40 g, 13.3 mmol), toluene (8 mL), degassed H₂O/EtOH (4.6 mL, v/v, 1:1), and a solution of (Ph₃P)₄Pd (15.7 mg, 0.0136 mmol) in toluene (2 mL). A yellow solid was obtained (2.08 g, 90%).

¹H NMR (C₆D₆): δ 8.35 (s, 1H, NCH), 8.04 (m, 1H), 7.98 (d, J=7.8 Hz, 1H), 7.65 (m, 1H), 7.60 (d, J=7.8 Hz, 1H), 7.49 (d, J=7.8 Hz, 4H), 7.34 (d, J=7.8 Hz, 2H), 7.32 (d, J=7.2 Hz, 1H), 7.28 (m, 2H), 7.20 (t, J=7.8 Hz, 1H), 7.08 (m, 9H) ppm.

¹³C NMR (C₆D₆): δ 119.22, 125.37, 126.01, 126.38, 126.56, 126.94, 128.33, 128.58, 129.21, 130.50, 130.60, 131.71, 134.10, 134.44, 136.75, 138.41, 140.65, 148.55, 154.69, 159.29, 166.55 ppm.

HRMS (EI): m/z calcd ([M⁺] C₃₄H₂₄N₂) 460.1939. Found: 460.1938.

Preparation was performed by the same method as in Example 1 using the compound (0.459 g, 0.996 mmol) and 2-isopropylphenyllithium (0.217 g, 1.72 mmol). A white solid was obtained (0.428 g, 74%).

¹H NMR (C₆D₆): δ 8.05 (d, J=8.4 Hz, 1H), 7.68 (d, J=8.4 Hz, 1H), 7.64 (d, J=8.4 Hz, 1H), 7.42 (d, J=8.4 Hz, 4H), 7.27 (m, 5H), 7.14 (d, J=7.2 Hz, 2H), 7.01 (m, 10H), 6.89 (m, 2H), 6.71 (d, J=7.8 Hz, 1H), 5.82 (d, J=10.8 Hz, 1H, NCH), 5.22 (d, J=10.8 Hz, 1H, NH), 2.97 (septet, J=6.0 Hz, 1H, CH), 1.01 (d, J=6.0 Hz, 3H, CH₃), 0.872 (d, J=6.0 Hz, 3H, CH₃) ppm.

¹³C NMR (C₆D₆): δ 23.96, 24.65, 28.57, 61.56, 119.97, 120.91, 122.67, 125.36, 125.52, 125.94, 126.19, 126.48, 162.87, 127.11, 127.34, 127.71, 128.44, 128.67, 129.03, 129.71, 130.99, 131.84, 133.29, 134.51, 136.40, 138.97, 140.04, 141.43, 143.23, 146.44, 158.85, 162.62 ppm.

HRMS (EI): m/z calcd ([M⁺] C₄₃H₃₆N₂) 580.2878. Found: 580.2881.

### (ii) Preparation of Transition Metal Compound

Preparation was performed by the same method as in Example 1 using the ligand compound (0.199 g, 0.343 mmol), n-BuLi (0.226 mL, a 1.6 M solution in hexane, 0.362 mmol), HfCl₄ (0.110 g, 0.345 mmol), MeMgBr (0.39 mL, a 3.1 M solution in diethyl ether, 1.2 mmol) and toluene (2.0 g). A dark yellow solid was obtained (0.178 g, 66%).

¹H NMR (C₆D₆): δ 8.54 (d, J=7.2 Hz, 1H), 8.33 (d, J=9.6 Hz, 1H), 7.76 (d, J=8.4 Hz, 1H), 7.71 (d, J=8.4 Hz, 1H), 7.57 (d, J=7.8 Hz, 2H), 7.51 (d, J=7.8 Hz, 1H), 7.27 (m, 6H), 7.11 (m, 4H), 7.01 (t, J=7.2 Hz, 1H), 6.96 (d, J=4.2 Hz, 2H), 6.76 (m, 3H), 6.68 (m, 2H), 6.34 (s, 1H, NCH), 6.11 (d, J=7.8 Hz, 1H), 3.15 (septet, J=6.6 Hz, 1H), 1.22 (d, J=6.6 Hz, 3H, CH₃), 0.93 (m, 6H, HfCH₃, CH₃), −0.08 (s, 3H, HfCH₃) ppm.

¹³C NMR (C₆D₆): δ 23.31, 25.55, 29.13, 64.26, 65.18, 74.07, 118.94, 119.86, 123.91, 124.29, 125.49, 125.74, 126.78, 126.91, 126.94, 127.16, 128.52, 129.69, 130.00, 130.72, 130.75, 131.44, 131.58, 131.95, 134.36, 135.72, 138.33, 139.89, 140.88, 141.19, 141.51, 143.09, 143.65, 146.42, 147.03, 163.90, 170.58, 206.23 ppm.

Anal. calcd. (C₄₅H₄₀HfN₂): C, 68.65; H, 5.12; N, 3.56%. Found: C, 68.37; H, 5.49; N, 3.25.

### Example 6

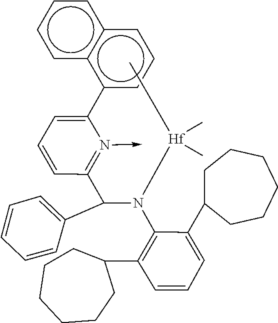

### (i) Preparation of Ligand Compound

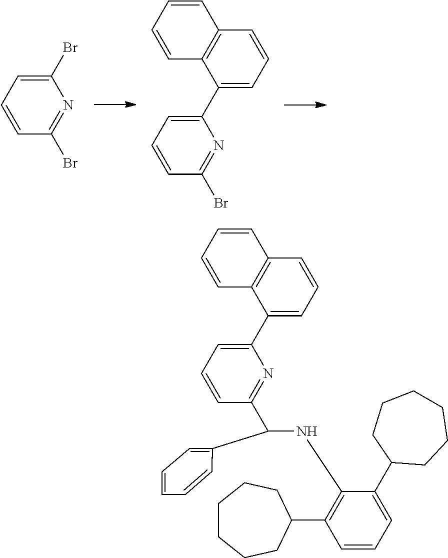

Under N₂, a Schlenk flask was charged with 2,6-dibromopyridine (7 g, 29.5 mmol), 1-naphthylboronic acid (2.54 g, 14.8 mmol), Na₂CO₃ (3.91 g, 36.9 mmol) and toluene (23 mL). Then, a degassed H₂O-EtOH mixture (1:1 [v/v], 4.67 mL) and a solution of (Ph₃P)₄Pd (85.3 mg, 0.0739 mmol in toluene (5 mL) were injected thereto. A two-phase solution was heated to 70° C. and vigorously stirred overnight. After cooling to room temperature, an organic phase was collected and washed with H₂O (20 mL). The product was extracted with toluene (3×20 mL). The organic phase thus collected was dried with anhydrous MgSO₄, and a solvent was removed in a rotary evaporator. The product was separated by column chromatography on silica gel using a mixture of hexane and toluene (1:2, v/v). A white solid was obtained (3.1 g, 74%).

¹H NMR (C₆D₆): δ 8.18 (d, J=8.4 Hz, 1H), 7.64 (d, J=8.4 Hz, 1H), 7.62 (d, J=8.4 Hz, 1H), 7.44 (d, J=6.6 Hz, 1H), 7.23 (m, 3H), 6.97 (d, J=8.4 Hz, 1H), 6.92 (d, J=7.2 Hz, 1H), 6.68 (t, J=7.8 Hz, 1H) ppm.

¹³C NMR (C₆D₆): δ 123.76, 125.41, 125.81, 126.21, 126.30, 126.94, 128.35, 128.70, 129.68, 131.41, 134.35, 137.31, 138.37, 142.22, 160.41 ppm. Anal. calcd. (C₁₅H₁₀BrN): C, 63.40; H, 3.55; N, 4.93%. Found: C, 63.39; H, 3.66; N, 4.62%.

The compound (0.609 g, 2.14 mmol) was dissolved in THE (8 mL) and cooled to about −78° C. t-BuLi (2.52 mL, a 1.7 M solution in hexane, 4.3 mmol) was introduced, and a mixture was stirred at about −78° C. for 2 hours. Then, a solution of 2,6-(cycloheptyl)₂C₆H₃N═C(H)Ph (0.800 g, 2.14 mmol) in THF (16 mL) was added thereto. After stirring at about −78° C. for 3 hours, the temperature of the solution thus produced was slowly raised to room temperature. After stirring overnight, water (10 mL) was added, and a product was extracted with ethyl acetate (3×10 mL). An organic phase was collected and dried with MgSO₄. A solvent was removed in a rotary evaporator. Through separation by column chromatography on silica gel using hexane and toluene containing a small amount of triethylamine (v/v, 75:25:1), a lemon yellow solid was obtained (0.412 g, 63%).

¹H NMR (C₆D₆): δ 8.27 (m, 1H), 7.67 (m, 2H), 7.60 (d, J=7.2 Hz, 3H), 7.28 (m, 3H), 7.18 (m, 2H), 7.10 (m, 6H), 6.89 (m, 1H), 5.32 (d, J=7.2 Hz, 1H, NCH), 5.18 (d, J=7.8 Hz, 1H, NH), 3.04 (m, 2H), 1.81 (m, 4H), 1.55 (m, 8H), 1.37 (m, 8H), 1.18 (m, 4H) ppm.

¹³C NMR (C₆D₆): δ 27.65, 27.84, 27.99, 37.20, 37.54, 40.48, 70.57, 120.30, 123.23, 124.06, 124.56, 125.34, 126.15, 126.59, 126.75, 127.17, 128.58, 128.63, 129.40, 131.86, 134.65, 137.10, 138.82, 142.71, 144.07, 144.87, 159.43, 162.82 ppm.

HRMS (EI): m/z calcd ([M⁺] C₄₂H₄₆N₂) 578.3661. Found: 578.3660.

### (ii) Preparation of Transition Metal Compound

Preparation was performed by the same method as in Example 1 using the ligand compound (0.120 g, 0.207 mmol), n-BuLi (a 1.6 M solution in hexane, 0.129 mL, 0.219 mmol), HfCl₄ (66.7 mg, 0.208 mmol), and MeMgBr (0.24 mL, a 3.0 M solution in diethyl ether, 0.73 mmol). A yellow solid was obtained (0.106 g, 65%).

¹H NMR (C₆D₆): δ 8.58 (d, J=7.2 Hz, 1H), 8.32 (d, J=8.4 Hz, 1H), 7.78 (d, J=7.2 Hz, 1H), 7.69 (d, J=7.8 Hz, 1H), 7.57 (d, J=7.2 Hz, 1H), 7.32 (m, 1H), 7.27 (m, 1H), 7.20 (m, 3H), 7.05 (m, 5H), 6.87 (t, J=7.8 Hz, 1H), 6.47 (d, J=7.2 Hz, 1H), 5.74 (s, 1H, NCH), 3.46 (m, 1H), 2.92 (m, 1H), 2.33 (m, 1H), 2.11 (m, 2H), 1.89 (m, 1H), 1.82 (m, 1H), 1.62 (m, 9H), 1.25 (m, 9H), 0.97 (s, 3H, HfCH₃), 0.66 (s, 3H, HfCH₃), 0.63 (m, 1H) ppm.

¹³C NMR (C₆D₆): δ 27.23, 27.44, 27.84, 28.12, 28.28, 28.90, 29.02, 37.49, 37.68, 39.85, 39.93, 40.29, 41.19, 62.50, 66.67, 84.17, 119.73, 120.33, 124.12, 125.33, 125.46, 125.52, 126.16, 127.00, 128.93, 129.16, 129.94, 130.03, 130.80, 134.27, 135.78, 140.78, 143.84, 143.92, 143.95, 148.04, 148.32, 164.51, 170.22, 206.25 ppm.

Anal. calcd. (C₄₄H₅₀HfN₂): C, 67.29; H, 6.42; N, 3.57%. Found: C, 67.18; H, 6.44; N, 3.31%.

### Example 7

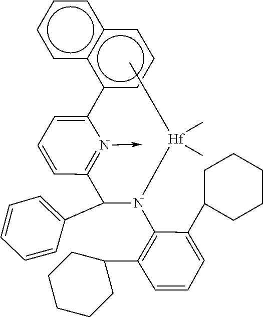

### (i) Preparation of Ligand Compound

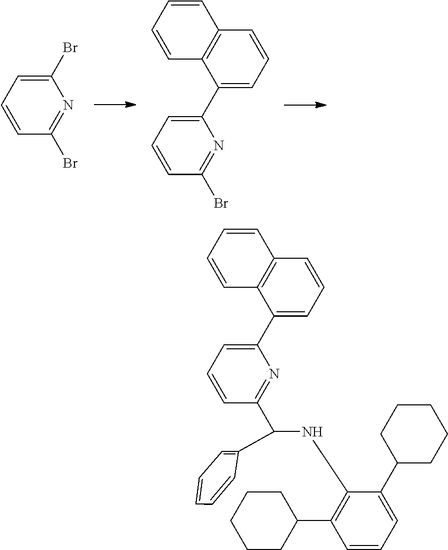

Preparation was performed by the same method as in Example 6 using 2-bromo-6-(naphthalene-1-yl)pyridine (0.156 g, 0.548 mmol), t-BuLi (0.65 mL, a 1.7 M solution in hexane, 1.1 mmol), 2,6-(cyclohexyl)₂C₆H₃N═C(H)Ph (0.189 g, 0.548 mmol), and THF (7 mL). Through separation by column chromatography on silica gel using hexane and toluene containing a small amount of triethylamine (v/v, 75:25:1), a pale yellow solid was obtained (0.208 g, 69%).

¹H NMR (C₆D₆): δ 8.30 (m, 1H), 7.67 (m, 2H), 7.61 (d, J=7.8 Hz, 3H), 7.28 (m, 3H), 7.19 (m, 2H), 7.10 (m, 6H), 6.83 (quintet, J=4.2 Hz, 1H), 5.31 (s, 1H, NCH), 5.24 (s, 1H, NH), 2.89 (m, 2H), 1.75 (d, J=12.6 Hz, 2H), 1.70 (d, J=12.6 Hz, 2H), 1.59 (d, J=13.2 Hz, 2H), 1.55 (d, J=12.6 Hz, 2H), 1.50 (d, J=12.6 Hz, 2H), 1.32 (m, 4H), 1.09 (m, 2H), 0.922 (m, 4H) ppm.

¹³C NMR (C₆D₆): δ 26.63, 27.18, 27.49, 34.75, 35.12, 38.98, 70.71, 120.32, 123.19, 123.81, 124.75, 125.38, 126.18, 126.59, 126.71, 127.19, 127.78, 128.60, 129.40, 131.85, 134.64, 137.11, 138.88, 141.90, 144.69, 144.94, 159.38, 162.73 ppm. HRMS (EI): m/z calcd ([M⁺] C₄₀H₄₂N₂) 550.3348. Found: 550.3350.

### (ii) Preparation of Transition Metal Compound

Preparation was performed by the same method as in Example 6 using HfCl₄ (0.124 g, 0.387 mmol), MeMgBr (0.51 mL, a 3.0 M solution in diethyl ether, 1.6 mmol) and the ligand compound (0.142 g, 0.258 mmol). A yellow solid was obtained (0.140 g, 72%).

¹H NMR (C₆D₆): δ 8.56 (d, J=8.4 Hz, 1H), 8.29 (d, J=7.8 Hz, 1H), 7.78 (d, J=7.8 Hz, 1H), 7.70 (d, J=7.8 Hz, 1H), 7.54 (d, J=7.2 Hz, 1H), 7.30 (m, 2H), 7.19 (m, 2H), 7.17 (m, 1H), 7.06 (m, 5H), 6.88 (t, J=7.8 Hz, 1H), 6.43 (d, J=7.2 Hz, 1H), 5.79 (s, 1H, NCH), 3.37 (m, 1H), 2.77 (m, 1H), 2.18 (d, J=12.6 Hz, 1H), 2.07 (m, 2H), 1.84 (d, J=12.0 Hz, 1H), 1.77 (d, J=12.0 Hz, 1H), 1.54 (m, 8H), 1.14 (m, 3H), 0.96 (s, 3H, HfCH₃), 0.89 (m, 3H), 0.65 (s, 3H, HfCH₃), 0.34 (m, 1H) ppm.

¹³C NMR (C₆D₆): δ 26.65, 26.74, 27.77, 28.28, 35.17, 35.59, 36.23, 38.00, 38.21, 40.83, 62.51, 66.95, 84.22, 119.46, 120.38, 124.19, 125.52, 125.61, 125.79, 126.05, 126.97, 127.76, 128.92, 129.11, 129.92, 130.00, 130.81, 134.33, 135.78, 140.78, 143.87, 144.00, 145.33, 145.79, 146.65, 164.58, 170.16, 206.09 ppm.

Anal. calcd. (C₄₂H₄₆HfN₂): C, 66.61; H, 6.12; N, 3.70%. Found: C, 66.89; H, 6.45; N, 3.51%.

### Example 8

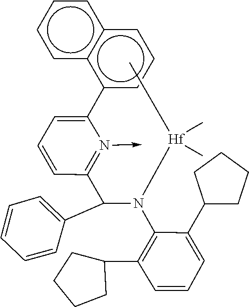

### (i) Preparation of Ligand Compound

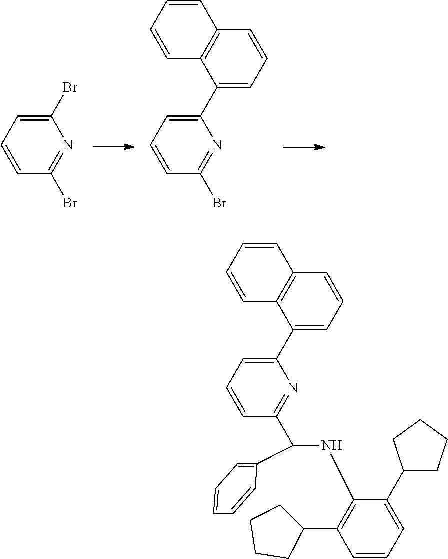 [SMILES: Brc1cccc(Br)n1 ; Brc1cccc(-c2cccc3ccccc23)n1 ; c1ccc(C(Nc2c(C3CCCC3)cccc2C2CCCC2)c2cccc(-c3cccc4ccccc34)n2)cc1]

Preparation was performed by the same method as in Example 6 using 2-bromo-6-(naphthalene-1-yl)pyridine (0.493 g, 1.74 mmol), t-BuLi (2.0 mL, a 1.7 M solution in hexane, 3.5 mmol), 2,6-(cyclopentyl)₂C₆H₃N═C(H)Ph (0.551 g, 1.74 mmol), and THF (20 mL). Through separation by column chromatography on silica gel using hexane and toluene containing a small amount of triethylamine (v/v, 75:25:1), a pale yellow solid was obtained (0.637 g, 70%).

¹H NMR (C₆D₆): δ 8.24 (m, 1H), 7.67 (m, 2H), 7.63 (d, J=7.2 Hz, 2H), 7.56 (d, J=6.6 Hz, 1H), 7.31 (d, J=8.4 Hz, 1H), 7.27 (m, 2H), 7.18 (m, 2H), 7.12 (d, J=6.6 Hz, 2H), 7.05 (m, 4H), 6.75 (m, 1H), 5.60 (d, J=7.2 Hz, 1H, NCH), 5.36 (d, J=8.4 Hz, 1H, NH), 3.37 (m, 2H), 1.87 (m, 2H), 1.78 (m, 2H), 1.58 (m, 4H), 1.49 (m, 4H), 1.26 (m, 4H) ppm.

¹³C NMR (C₆D₆): δ 25.93, 25.98, 35.46, 35.53, 40.64, 70.33, 120.66, 123.17, 123.59, 124.68, 125.42, 126.18, 126.53, 126.61, 127.21, 127.68, 127.83, 128.59, 128.63, 129.35, 131.79, 134.59, 136.94, 138.95, 139.70, 144.67, 146.13, 159.25, 162.51 ppm.

HRMS (EI): m/z calcd ([M⁺] C₃₈H₃₈N₂) 522.3035. Found: 522.3033.

### (ii) Preparation of Transition Metal Compound

Preparation was performed by the same method as in Example 6 using HfCl₄ (0.184 g, 0.587 mmol), MeMgBr (0.76 mL, a 3.0 M solution in diethyl ether, 2.4 mmol) and the ligand compound (0.200 g, 0.383 mmol). A yellow solid was obtained (0.226 g, 81%).

¹H NMR (C₆D₆): δ 8.57 (d, J=7.8 Hz, 1H), 8.24 (d, J=8.4 Hz, 1H), 7.80 (d, J=7.8 Hz, 1H), 7.71 (d, J=7.2 Hz, 1H), 7.47 (d, J=8.4 Hz, 1H), 7.27 (m, 3H), 7.19 (t, J=7.8 Hz, 1H), 7.14 (m, 1H), 7.01 (m, 5H), 6.80 (t, J=4.2 Hz, 1H), 6.40 (d, J=7.8 Hz, 1H), 5.93 (s, 1H, NCH), 3.74 (m, 1H), 3.43 (quintet, J=9.6 Hz, 1H), 2.40 (m, 1H), 2.20 (m, 1H), 2.10 (m, 1H), 1.69 (m, 8H), 1.33 (m, 3H), 1.06 (m, 1H), 0.91 (s, 3H, HfCH₃), 0.66 (s, 3H, HfCH₃), 0.34 (m, 1H) ppm.

¹³C NMR (C₆D₆): δ 26.18, 26.22, 26.86, 27.19, 36.74, 37.53, 39.17, 40.67, 41.04, 62.26, 66.85, 84.05, 119.56, 120.49, 124.17, 125.10, 125.51, 125.85, 126.26, 126.96, 128.91, 129.04, 129.91, 129.98, 130.74, 134.15, 135.73, 140.82, 143.94, 144.04, 145.01, 145.67, 146.68, 164.60, 170.03, 205.87 ppm.

Anal. calcd. (C₄₀H₄₂HfN₂): C, 65.88; H, 5.80; N, 3.84%. Found: C, 65.94; H, 5.72; N, 3.75%.

### Comparative Example 1

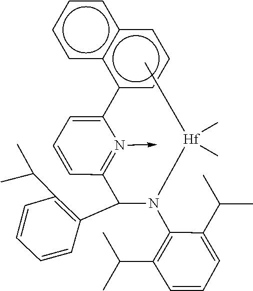

The above compound was prepared according to a known method.

### Comparative Example 2

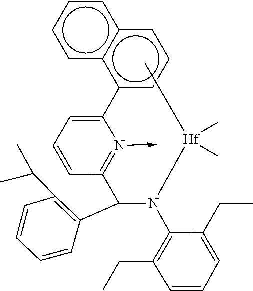

### (i) Preparation of Ligand Compound

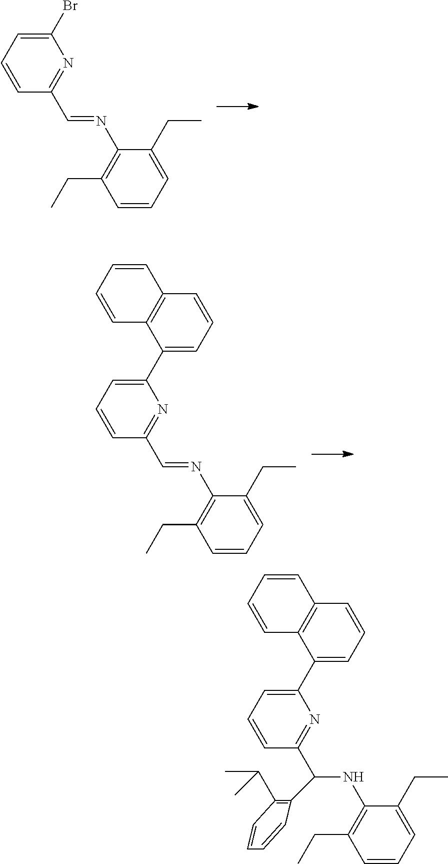

Preparation was performed by the same method as in Example 1 using 2,6-diethylaniline (1.50 g, 10.1 mmol), 6-bromo-2-pyridinecarboxaldehyde (1.87 g, 10.1 mmol) and toluene (15 mL). A lemon yellow solid was obtained (2.51 g, 79%).

¹H NMR (C₆D₆): δ 8.23 (s, 1H, NCH), 7.96 (d, J=7.2 Hz, 1H), 7.01 (s, 3H), 6.87 (d, J=7.8 Hz, 1H), 6.62 (t, J=8.4 Hz, 1H), 2.44 (quartet, J=7.2 Hz, 4H, CH₂), 1.06 (t, J=7.8 Hz, 6H, CH₃) ppm.

¹³C NMR (C₆D₆): δ 14.88, 25.13, 119.46, 125.02, 126.84, 129.70, 132.90, 138.73, 142.29, 149.89, 155.89, 162.16 ppm.

HRMS (EI): m/z calcd ([M⁺] C₁₆H₁₇BrN₂) 316.0575. Found: 316.0574.

Preparation was performed by the same method as in Example 1 using the compound (2.34 g, 7.02 mmol), 1-naphthylboronic acid (1.27 g, 7.37 mmol), Na₂CO₃ (1.96 g, 18.5 mmol), toluene (10 mL), degassed H₂O/EtOH (6.5 mL, v/v, 1:1), and a solution of (Ph₃P)₄Pd (21.9 mg, 0.0190 mmol) in toluene (2 mL). Through recrystallization in hexane and toluene at −30° C., an analytically pure compound was obtained. A yellow solid was obtained (2.35 g, 92%).

¹H NMR (C₆D₆): δ 8.56 (s, 1H, NCH), 8.33 (d, J=7.2 Hz, 1H), 8.29 (m, 1H), 7.69 (t, J=2.4 Hz, 1H), 7.67 (d, J=8.4 Hz, 1H), 7.58 (d, J=6.6 Hz, 1H), 7.26 (m, 5H), 7.04 (m, 3H), 2.56 (quartet, J=7.2 Hz, 4H, CH₂), 1.14 (t, J=7.2 Hz, 6H, CH₃) ppm.

¹³C NMR (C₆D₆): δ 14.93, 25.26, 119.24, 124.76, 125.54, 126.17, 126.19, 126.69, 126.83, 128.17, 128.76, 129.37, 131.80, 133.06, 134.53, 136.97, 138.69, 150.49, 155.13, 159.66, 164.12 ppm.

HRMS (EI): m/z calcd ([M⁺] C₂₆H₂₄N₂) 364.1939. Found: 364.1938.

Preparation was performed by the same method as in Example 1 using the compound (0.400 g, 1.10 mmol) and 2-isopropylphenyllithium (0.239 g, 1.90 mmol). A lemon yellow solid was obtained (0.432 g, 82%).

¹H NMR (C₆D₆): δ 8.18 (m, 1H), 7.79 (m, 1H), 7.66 (m, 1H), 7.64 (d, J=7.8 Hz, 1H), 7.50 (d, J=7.8 Hz, 1H), 7.27 (m, 3H), 7.18 (m, 2H), 7.14 (m, 2H), 7.01 (m, 5H), 5.83 (s, 1H, NCH), 4.78 (s, 1H, NH), 3.33 (septet, J=6.6 Hz, 1H, CH), 2.50 (m, 4H, CH₂), 1.02 (m, 12H, CH₃) ppm.

¹³C NMR (C₆D₆): δ 14.95, 23.99, 24.84, 25.05, 28.93, 65.42, 120.00, 122.97, 123.18, 125.40, 125.86, 126.07, 126.37, 126.60, 126.62, 127.09, 127.69, 127.84, 128.58, 129.28, 131.88, 134.57, 136.90, 137.01, 138.95, 141.42, 145.44, 146.52, 159.21, 163.41 ppm.

HRMS (EI): m/z calcd ([M⁺] C₃₅H₃₆N₂) 484.2878. Found: 484.2876.

### (ii) Preparation of Transition Metal Compound

A Schlenk flask was charged with the HfCl₄ (0.189 g, 0.588 mmol) and toluene (5 mL). Under N₂, the temperature was reduced to about −78° C., and MeMgBr (0.78 mL, a 3.1 M solution in diethyl ether, 2.4 mmol) was added thereto dropwisely. The mixture was stirred at −40 to −35° C. for 1 hour to precipitate a white solid. The temperature was reduced to about −78° C. again, and a solution of the ligand compound (0.190 g, 0.392 mmol) in toluene (5 mL) was added thereto dropwisely. After stirring the mixture thus produced at −40 to −35° C. for 2 hour, the temperature was slowly raised to room temperature. After stirring overnight, all volatile materials were removed through a vacuum line. A product was extracted with toluene (10 mL). The extract was filtered on a celite and collected. After removing a solvent through a vacuum line, the residue was softened in hexane (2 mL). A yellow solid was obtained (0.170 g, 63%).

¹H NMR (C₆D₆): δ 8.58 (d, J=7.2 Hz, 1H), 8.35 (d, J=9.0 Hz, 1H), 7.82 (d, J=8.4 Hz, 1H), 7.73 (d, J=7.8 Hz, 1H), 7.56 (d, J=7.8 Hz, 1H), 7.36 (t, J=7.2 Hz, 1H), 7.30 (t, J=6.6 Hz, 1H), 7.22 (d, J=7.8 Hz, 1H), 7.14 (d, J=7.8 Hz, 1H), 7.09 (t, J=7.8 Hz, 2H), 7.04 (m, 2H), 6.93 (t, J=7.8 Hz, 1H), 6.84 (t, J=7.8 Hz, 1H), 6.60 (s, 1H, NCH), 6.47 (d, J=7.8 Hz, 1H), 2.83 (m, 4H, CH₂), 2.41 (m, 1H, CH), 1.30 (t, J=7.8 Hz, 3H, CH₃), 1.14 (d, J=6.6 Hz, 3H, CH₃), 0.82 (s, 3H, HfCH₃), 0.68 (d, J=6.6 Hz, 3H, CH₃), 0.62 (t, J=7.2 Hz, 3H, CH₃), 0.56 (s, 3H, HfCH₃) ppm.

¹³C NMR (C₆D₆): δ 14.88, 15.20, 22.85, 24.20, 24.34, 25.57, 28.61, 63.61, 64.75, 74.63, 120.14, 120.30, 124.20, 125.33, 125.54, 126.01, 126.42, 126.71, 126.85, 127.01, 129.91, 130.05, 130.57, 130.70, 134.30, 135.76, 140.67, 140.76, 142.33, 143.79, 143.83, 144.26, 147.16, 164.52, 171.23, 205.38 ppm.

Anal. calcd. (C₃₇H₄₀HfN₂): C, 64.29; H, 5.83; N, 4.05%. Found: C, 64.41; H, 6.05; N, 3.86%.

### Comparative Example 3

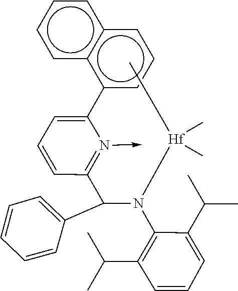

### (i) Preparation of Ligand Compound

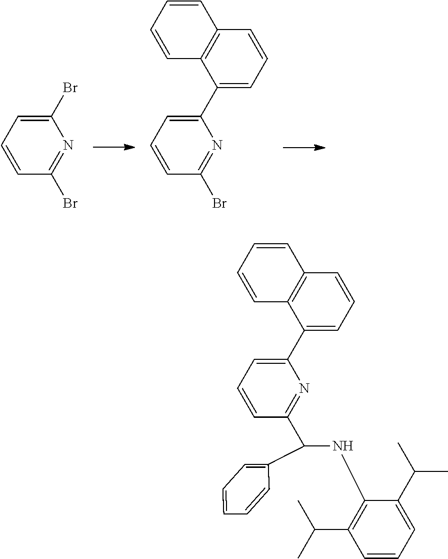 [SMILES: Brc1cccc(Br)n1 ; Brc1cccc(-c2cccc3ccccc23)n1 ; CC(C)c1cccc(C(C)C)c1NC(c1ccccc1)c1cccc(-c2cccc3ccccc23)n1]

Preparation was performed by the same method as in Example 6 using 2-bromo-6-(naphthalene-1-yl)pyridine (0.220 g, 0.774 mmol), t-BuLi (0.91 mL, a 1.7 M solution in hexane, 1.6 mmol), 2,6-Et₂C₆H₃N═C(H)Ph (0.184 g, 0.774 mmol), and THE (10 mL). By separating using column chromatography on silica gel using hexane and toluene containing a small amount of triethylamine (v/v, 75:25:1), a pale yellow solid was obtained (0.210 g, 61%).

¹H NMR (C₆D₆): δ 8.21 (m, 1H), 7.68 (m, 2H), 7.54 (d, J=7.2 Hz, 1H), 7.51 (d, J=8.4 Hz, 2H), 7.30 (t, J=7.2 Hz, 1H), 7.26 (m, 2H), 7.11 (t, J=7.8 Hz, 2H), 7.05 (m, 2H), 7.00 (m, 3H), 6.93 (m, 1H), 6.80 (m, 1H), 5.59 (d, J=8.4 Hz, 1H, NCH), 5.52 (d, J=8.4 Hz, 1H, NH), 2.62 (m, 4H, CH₂), 1.06 (t, J=6.6 Hz, 6H, CH₃) ppm.

¹³C NMR (C₆D₆): δ 14.82, 25.47, 68.09, 120.75, 122.56, 123.35, 125.48, 126.16, 126.50, 126.63, 127.09, 127.24, 127.73, 127.81, 128.60, 128.65, 129.28, 131.84, 134.54, 136.08, 136.94, 139.08, 144.24, 144.89, 159.17, 162.33 ppm. HRMS (EI): m/z calcd ([M⁺] C₃₂H₃₀N₂) 442.2409. Found: 442.2408.

### (ii) Preparation of Transition Metal Compound

Preparation was performed by the same method as in Example 6 using HfCl₄ (0.0709 g, 0.221 mmol), MeMgBr (0.29 mL, a 3.0 M solution in diethyl ether, 0.91 mmol) and the ligand compound (0.0653 g, 0.148 mmol). A yellow solid was obtained (0.0628 g, 66%).

¹H NMR (C₆D₆): δ 8.57 (d, J=7.2 Hz, 1H), 8.35 (d, J=8.4 Hz, 1H), 7.82 (d, J=7.8 Hz, 1H), 7.73 (d, J=8.4 Hz, 1H), 7.56 (d, J=8.4 Hz, 1H), 7.36 (t, J=7.2 Hz, 1H), 7.30 (t, J=7.8 Hz, 1H), 7.23 (d, J=7.2 Hz, 1H), 7.18 (m, 1H), 7.12 (d, J=7.8 Hz, 1H), 6.96 (m, 3H), 6.83 (m, 3H), 6.36 (d, J=7.8 Hz, 1H), 5.93 (s, 1H, NCH), 2.84 (sextet, J=7.2 Hz, 1H, CH₂), 2.78 (sextet, J=7.8 Hz, 1H, CH₂), 2.69 (sextet, J=6.6 Hz, 1H, CH₂), 2.38 (sextet, J=6.6 Hz, 1H, CH₂), 1.32 (t, J=7.8 Hz, 3H, CHs), 0.80 (s, 3H, HfCH₃), 0.61 (t, J=7.2 Hz, 3H, CH₃), 0.55 (s, 3H, HfCH₃) ppm.

¹³C NMR (C₆D₆): δ 15.28, 15.68, 24.37, 63.72, 64.58, 81.45, 120.29, 120.49, 124.13, 125.56, 126.09, 126.69, 126.74, 127.05, 127.82, 128.76, 129.38, 129.90, 130.06, 130.65, 134.32, 135.74, 140.68, 142.53, 143.15, 143.73, 144.00, 144.24, 164.59, 170.07, 205.27 ppm.

Anal. calcd. (C₃₄H₃₄HfN₂): C, 62.91; H, 5.28; N, 4.32%. Found: C, 63.13; H, 5.50; N, 4.41%.

### Comparative Example 4

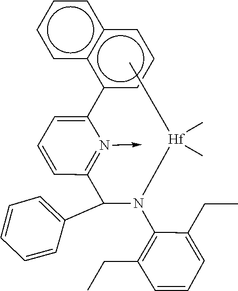

### (i) Preparation of Ligand Compound

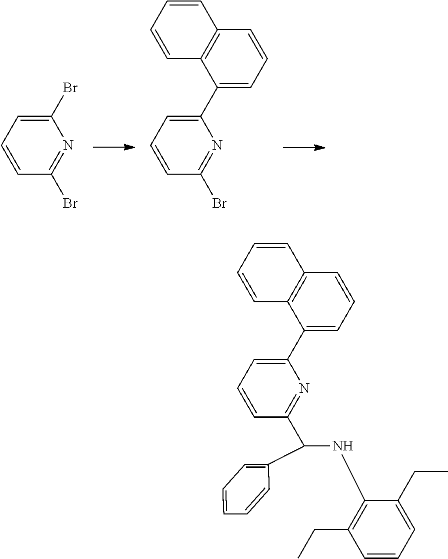 [SMILES: Brc1cccc(Br)n1 ; Brc1cccc(-c2cccc3ccccc23)n1 ; CCc1cccc(CC)c1NC(c1ccccc1)c1cccc(-c2cccc3ccccc23)n1]

Preparation was performed by the same method as in Example 6 using 2-bromo-6-(naphthalene-1-yl)pyridine (0.220 g, 0.774 mmol), t-BuLi (0.91 mL, a 1.7 M solution in hexane, 1.6 mmol), 2,6-Et₂C₆H₃N═C(H)Ph (0.184 g, 0.774 mmol), and THE (10 mL). By separating using column chromatography on silica gel using hexane and toluene containing a small amount of triethylamine (v/v, 75:25:1), a pale yellow solid was obtained (0.210 g, 61%).

¹H NMR (C₆D₆): δ 8.21 (m, 1H), 7.68 (m, 2H), 7.54 (d, J=7.2 Hz, 1H), 7.51 (d, J=8.4 Hz, 2H), 7.30 (t, J=7.2 Hz, 1H), 7.26 (m, 2H), 7.11 (t, J=7.8 Hz, 2H), 7.05 (m, 2H), 7.00 (m, 3H), 6.93 (m, 1H), 6.80 (m, 1H), 5.59 (d, J=8.4 Hz, 1H, NCH), 5.52 (d, J=8.4 Hz, 1H, NH), 2.62 (m, 4H, CH₂), 1.06 (t, J=6.6 Hz, 6H, CH₃) ppm.

¹³C NMR (C₆D₆): δ 14.82, 25.47, 68.09, 120.75, 122.56, 123.35, 125.48, 126.16, 126.50, 126.63, 127.09, 127.24, 127.73, 127.81, 128.60, 128.65, 129.28, 131.84, 134.54, 136.08, 136.94, 139.08, 144.24, 144.89, 159.17, 162.33 ppm. HRMS (EI): m/z calcd ([M⁺] C₃₂H₃₀N₂) 442.2409. Found: 442.2408.

### (ii) Preparation of Transition Metal Compound

Preparation was performed by the same method as in Example 6 using HfCl₄ (0.0709 g, 0.221 mmol), MeMgBr (0.29 mL, a 3.0 M solution in diethyl ether, 0.91 mmol) and 31 (0.0653 g, 0.148 mmol). A yellow solid was obtained (0.0628 g, 66%).

¹H NMR (C₆D₆): δ 8.57 (d, J=7.2 Hz, 1H), 8.35 (d, J=8.4 Hz, 1H), 7.82 (d, J=7.8 Hz, 1H), 7.73 (d, J=8.4 Hz, 1H), 7.56 (d, J=8.4 Hz, 1H), 7.36 (t, J=7.2 Hz, 1H), 7.30 (t, J=7.8 Hz, 1H), 7.23 (d, J=7.2 Hz, 1H), 7.18 (m, 1H), 7.12 (d, J=7.8 Hz, 1H), 6.96 (m, 3H), 6.83 (m, 3H), 6.36 (d, J=7.8 Hz, 1H), 5.93 (s, 1H, NCH), 2.84 (sextet, J=7.2 Hz, 1H, CH₂), 2.78 (sextet, J=7.8 Hz, 1H, CH₂), 2.69 (sextet, J=6.6 Hz, 1H, CH₂), 2.38 (sextet, J=6.6 Hz, 1H, CH₂), 1.32 (t, J=7.8 Hz, 3H, CH₃), 0.80 (s, 3H, HfCH₃), 0.61 (t, J=7.2 Hz, 3H, CH₃), 0.55 (s, 3H, HfCH₃) ppm.

¹³C NMR (C₆D₆): δ 15.28, 15.68, 24.37, 63.72, 64.58, 81.45, 120.29, 120.49, 124.13, 125.56, 126.09, 126.69, 126.74, 127.05, 127.82, 128.76, 129.38, 129.90, 130.06, 130.65, 134.32, 135.74, 140.68, 142.53, 143.15, 143.73, 144.00, 144.24, 164.59, 170.07, 205.27 ppm.

Anal. calcd. (C₃₄H₃₄HfN₂): C, 62.91; H, 5.28; N, 4.32%. Found: C, 63.13; H, 5.50; N, 4.41%.

### Polymerization of Ethylene/Alpha-Olefin Copolymer

A bomb reactor (125 mL) was emptied at 60° C. for 1 hour. After charging the bomb reactor with an ethylene gas under an atmospheric pressure, a solution of Me₃Al (28.8 mg, 200 μmol-Al) in methylcyclohexane (15.5 g) was added to the reactor. The mixture thus obtained was stirred at 100° C. for 1 hour using a mantle, and then, a solution was removed using a cannular. The reactor was emptied again to remove remaining solvents, and recharged with an ethylene gas under an atmospheric pressure. This procedure was performed for purge catalyst poison.

The reactor was charged with methylcyclohexane (15.5 g) containing MMAO (AkzoNobel, 6.7 wt %-Al in heptane, 20 mg, 50 μmol-Al), and the temperature was set to 80° C. A solution of (1-hexyl)₂Zn (150 μmol) in methylcyclohexane (10.0 g) was supplied. Then, a methylcyclohexane solution (0.30 g) containing each transition metal compound (1.0 μmol-Hf) of the Examples or Comparative Examples activated with [(C₁₈H₃₇)₂N(H)Me]⁺[B(C₆F₅)₄]⁻ (1.0 eq) in benzene was injected.

The reactor was charged with an ethylene/propylene mixture gas (15 bar/10 bar, total 25 bar) at 23 bar in a tank, and polymerization was performed at 80-90° C. for 70 minutes. The remaining ethylene/propylene mixture gas was exhausted, and through drying in a vacuum oven of 160° C. overnight, an ethylene/propylene copolymer was obtained.

### Experimental Example 1

### (1) Yield (g)

The weights of the ethylene/alpha-olefin copolymers prepared through the Experimental Example were measured, and yields were calculated.

### (2) Propylene Content

Measurement was conducted by ¹H NMR spectrum.

### (3) Weight Average Molecular Weight (Mw), Number Average Molecular Weight (Mn) and Molecular Weight Distribution (MWD)

Measurement was conducted by GPC using trichlorobenzene at 160° C. and standardizing by polystyrene. By using Mw and Mn thus measured, MWD was calculated by dividing a Mw value by a Mn value.

TABLE 1

| | (hexyl)₂Zn | Yield | [C₃H₆] | Mn | |
|---|---|---|---|---|---|
| Catalyst | (μmol) | (g) | (mol %) | (kDa) | MWD |
| Example 1 | 150 | 10.2 | 20 | 28 | 1.9 |
| Example 2 | 150 | 10.0 | 20 | 33 | 1.7 |
| Example 3 | 150 | 8.1 | 18 | 25 | 1.4 |
| Example 4 | 150 | 9.0 | 18 | 18 | 1.8 |
| Example 5 | 150 | 8.8 | 19 | 22 | 1.5 |
| Example 6 | 150 | 7.0 | 14 | 22 | 1.6 |
| Example 7 | 150 | 7.7 | 16 | 19 | 1.5 |
| Example 8 | 150 | 6.2 | 16 | 19 | 1.4 |
| Comparative | 150 | 6.0 | 20 | 27 | 1.8 |
| Example 1 | | | | | |
| Comparative | 150 | 5.8 | 18 | 19 | 1.4 |
| Example 2 | | | | | |
| Comparative | 150 | 5.3 | 16 | 19 | 1.4 |
| Example 3 | | | | | |
| Comparative | 150 | 3.9 | 14 | 14 | 1.5 |
| Example 4 | | | | | |

From the polymerization results, the transition metal compounds of the Examples generally showed higher catalyst activity when compared with the transition metal compounds of the Comparative Examples, and could prepare ethylene/alpha-olefin copolymers with excellent yields.

For example, the transition metal compounds of Examples 1 and 2 could be used for polymerization for longer time when compared with Comparative Example 1. Particularly, it could be found that the monomer was hardly consumed after the lapse of 40 minutes in Comparative Example 1, and on the contrary, the monomer was steadily consumed until about 70 minutes in Examples 1 and 2.

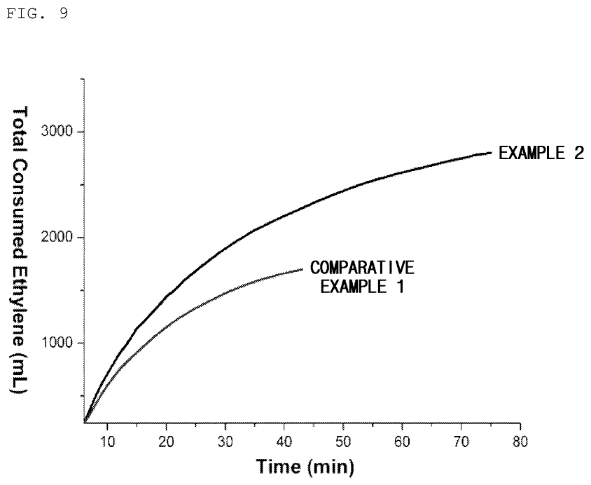

In addition, referring to FIG. 9, an experiment on observing the consuming ratio of ethylene using a mass flow controller was conducted by supplying ethylene with a constant pressure (10 bar) instead of the ethylene-propylene gas mixture, and it was confirmed that the transition metal compound of Example 2 maintained catalyst activity for a longer time when compared with the transition metal compound of Comparative Example 1.

1. A ligand compound represented by the following Formula 2, or selected from the following compound: 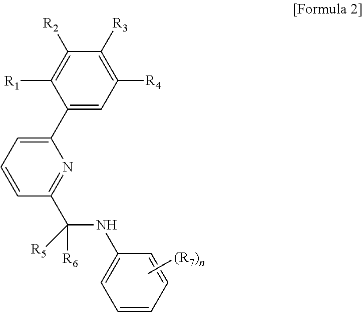
in Formula 2,
R₁ to R₄ are each independently hydrogen; a substituted or unsubstituted alkyl group of 1 to 20 carbon atoms; a substituted or unsubstituted cycloalkyl group of 3 to 20 carbon atoms; or a substituted or unsubstituted aryl group of 6 to 20 carbon atoms, where adjacent two or more among R₁ to R₄ are optionally connected with each other to form a ring,
R₅ and R₆ are each independently hydrogen; a substituted or unsubstituted alkyl group of 1 to 20 carbon atoms; a substituted or unsubstituted cycloalkyl group of 3 to 20 carbon atoms; a substituted or unsubstituted aryl group of 6 to 20 carbon atoms, where the substitution is conducted with an alkyl group of 1 to 12 carbon atoms,
each R₇ is independently a substituted or unsubstituted cycloalkyl group of 4 to 20 carbon atoms; or a substituted or unsubstituted aryl group of 6 to 20 carbon atoms, and
n is 1 to 5, 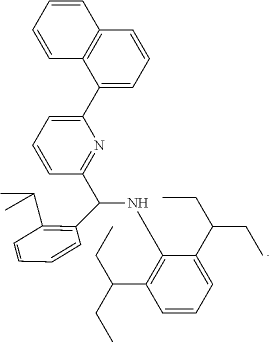 [SMILES: CCC(CC)c1cccc(C(CC)CC)c1NC(c1cccc(-c2cccc3ccccc23)n1)c1ccccc1C(C)C]
